(19) United States
(12) Patent Application Publication
(10) Pub. No.: US 2024/0157893 A1
(43) Pub. Date: May 16, 2024

(54) VEHICLE-MOUNTED RELAY DEVICE, MANAGEMENT DEVICE, VEHICLE-MOUNTED SYSTEM, AND COMMUNICATION MANAGEMENT METHOD

(71) Applicant: Sumitomo Electric Industries, Ltd., Osaka-shi, Osaka (JP)

(72) Inventors: Yoshikazu ISOYAMA, Osaka-shi, Osaka (JP); Kunito FUKUDA, Osaka-shi, Osaka (JP)

(73) Assignee: Sumitomo Electric Industries, Ltd., Osaka-shi, Osaka (JP)

(21) Appl. No.: 18/281,307

(22) PCT Filed: Dec. 24, 2021
(86) PCT No.: PCT/JP2021/048221

§ 371 Date: Sep. 11, 2023

(30) Foreign Application Priority Data
Mar. 12, 2021 (JP) 2021-039794
Aug. 20, 2021 (JP) 2021-134479

(51) Int. Cl. B60R 16/023; H04B 3/36; H04L 9/08; H04L 9/32; H04L 12/40; H04L 67/12

(52) U.S. Cl. CPC B60R 16/023; H04B 3/36; H04L 9/0822; H04L 9/0861; H04L 9/3236; H04L 12/40; H04L 67/12; H04L 2012/40273

(57) ABSTRACT

A vehicle-mounted relay device includes a relay unit configured to perform relay processing of transmitting each of a plurality of frames received from a corresponding one of a plurality of vehicle-mounted devices to a corresponding one of the plurality of vehicle-mounted devices serving as destinations, a determination unit configured to determine that the plurality of frames include a start-request for starting a session of communication between the plurality of vehicle-mounted devices and that the plurality of frames include a start-response to the start-request, a generation unit configured to generate, on a session-by-session basis, a common key to be used in the session attended by, among the plurality of vehicle-mounted devices, a vehicle-mounted device serving as a source of the frame determined to include the start-request by the determination unit and one or more vehicle-mounted devices serving as a source of the frame, and a transmission unit.

### TECHNICAL FIELD

The present disclosure relates to a vehicle-mounted relay device, a management device, a vehicle-mounted system, and a communication management method. This application claims priority based on Japanese Patent Applications No. 2021-39794 filed on Mar. 12, 2021 and No. 2021-134479 filed on Aug. 20, 2021, and the entire contents of the Japanese patent applications are incorporated herein by reference.

### BACKGROUND

PTL 1 (Japanese Unexamined Patent Application Publication No. 2018-26791) discloses the following frame transmission blocking device. That is, a frame transmission blocking device is connected to a bus in a network system in which a plurality of electronic control units communicate via the bus. The frame transmission blocking device includes a reception unit that receives a frame from the bus, and a processing unit that switches whether or not to execute a predetermined process of blocking transmission of the frame when the frame received by the reception unit satisfies a predetermined condition, based on management information indicating whether or not to allow blocking of transmission of the frame.

### PRIOR ART DOCUMENT

### Patent Literature

PTL 1: Japanese Unexamined Patent Application Publication No. 2018-26791

### SUMMARY

A vehicle-mounted relay device of the present disclosure includes a relay unit configured to perform relay processing of transmitting each of a plurality of frames received from a corresponding one of a plurality of vehicle-mounted devices to a corresponding one of the plurality of vehicle-mounted devices serving as destinations; a determination unit configured to determine that the plurality of frames include a start-request for starting a session of communication between the plurality of vehicle-mounted devices and that the plurality of frames include a start-response to the start-request; a generation unit configured to generate, on a session-by-session basis, a common key to be used in the session attended by, among the plurality of vehicle-mounted devices, a vehicle-mounted device serving as a source of the frame determined to include the start-request by the determination unit and one or more vehicle-mounted devices serving as a source of the frame determined to include the start-response by the determination unit; and a transmission unit configured to transmit the common key via the relay unit to the respective vehicle-mounted devices that are to attend the session.

A management device of the present disclosure used in a vehicle-mounted system including a plurality of vehicle-mounted devices, the management device includes a reception unit configured to receive a start-request for starting a session of communication between multiple vehicle-mounted devices which are some or all of the plurality of vehicle-mounted devices, and a start-response to the start-request, the start-request and the start-response each being received from a corresponding one of the multiple vehicle-mounted devices; a generation unit configured to generate a common key, the common key being to be used in the session associated with the start-request and the start-response and being unique to the session; and a transmission unit configured to transmit the common key to the respective vehicle-mounted devices that are to attend the session.

A vehicle-mounted system of the present disclosure includes a plurality of vehicle-mounted devices including a first vehicle-mounted device and a second vehicle-mounted device; and a vehicle-mounted relay device. The vehicle-mounted relay device is configured to perform relay processing of transmitting each of a plurality of frames received from a corresponding one of the plurality of vehicle-mounted devices to a corresponding one of the plurality of vehicle-mounted devices serving as destinations. The first vehicle-mounted device is configured to transmit, to the vehicle-mounted relay device, a first frame including a start-request for starting a session of communication between multiple vehicle-mounted devices which are some or all of the plurality of vehicle-mounted devices. The second vehicle-mounted device is configured to transmit, to the vehicle-mounted relay device, a second frame including a start-response to the start-request. The vehicle-mounted relay device is configured to generate, on a session-by-session basis, a common key to be used in the session attended by the first vehicle-mounted device serving as a source of the first frame that has been received and the second vehicle-mounted device serving as a source of the second frame that has been received, and transmit the generated common key to the respective vehicle-mounted devices that are to attend the session.

A vehicle-mounted system of the present disclosure includes a plurality of vehicle-mounted devices including a first vehicle-mounted device and a second vehicle-mounted device; and a management device. The first vehicle-mounted device is configured to transmit, to the management device, a start-request for starting a session of communication between multiple vehicle-mounted devices which are some or all of the plurality of vehicle-mounted devices, the second vehicle-mounted device is configured to transmit, to the management device, a start-response to the start-request, and the management device is configured to generate a common key, the common key being to be used in the session associated with the start-request and the start-response that have been received and being unique to the session, and transmit the generated common key to the respective vehicle-mounted devices that are to attend the session.

A communication management method of the present disclosure for a vehicle-mounted relay device configured to perform relay processing of transmitting each of a plurality of frames received from a corresponding one of a plurality of vehicle-mounted devices to a corresponding one of the plurality of vehicle-mounted devices serving as destinations, the communication management method includes determining that the plurality of frames include a start-request for starting a session of communication between the plurality of vehicle-mounted devices and that the plurality of frames include a start-response to the start-request; generating, on a session-by-session basis, a common key to be used in the session attended by, among the plurality of vehicle-mounted devices, a vehicle-mounted device serving as a source of the frame determined to include the start-request and one or more vehicle-mounted devices serving as a source of the frame determined to include the start-response; and transmitting the generated common key to the respective vehicle-mounted devices that are to attend the session.

A communication management method of the present disclosure for a management device used in a vehicle-mounted system including a plurality of vehicle-mounted devices, the communication management method includes receiving a start-request for starting a session of communication between multiple vehicle-mounted devices which are some or all of the plurality of vehicle-mounted devices, and a start-response to the start-request, the start-request and the start-response each being received from a corresponding one of the multiple vehicle-mounted devices; generating a common key, the common key being to be used in the session associated with the received start-request and start-response and being unique to the session; and transmitting the generated common key to the respective vehicle-mounted devices that are to attend the session.

A communication management method of the present disclosure for a vehicle-mounted system including a plurality of vehicle-mounted devices including a first vehicle-mounted device and a second vehicle-mounted device, and a vehicle-mounted relay device configured to perform relay processing of transmitting each of a plurality of frames received from a corresponding one of the plurality of vehicle-mounted devices to a corresponding one of the plurality of vehicle-mounted devices serving as destinations, the communication management method includes transmitting, by the first vehicle-mounted device, to the vehicle-mounted relay device, a first frame including a start-request for starting a session of communication between multiple vehicle-mounted devices which are some or all of the plurality of vehicle-mounted devices; transmitting, by the second vehicle-mounted device, to the vehicle-mounted relay device, a second frame including a start-response to the start-request; and generating, by the vehicle-mounted relay device, on a session-by-session basis, a common key to be used in the session attended by the first vehicle-mounted device serving as a source of the first frame that has been received and the second vehicle-mounted device serving as a source of the second frame that has been received, and transmitting, by the vehicle-mounted relay device, the generated common key to the respective vehicle-mounted devices that are to attend the session.

A communication management method of the present disclosure for a vehicle-mounted system including a plurality of vehicle-mounted devices including a first vehicle-mounted device and a second vehicle-mounted device, and a management device, the communication management method includes transmitting, by the first vehicle-mounted device, to the management device, a start-request for starting a session of communication between multiple vehicle-mounted devices which are some or all of the plurality of vehicle-mounted devices; transmitting, by the second vehicle-mounted device, to the management device, a start-response to the start-request; and generating, by the management device, a common key, the common key being to be used in the session associated with the start-request and the start-response that have been received and being unique to the session, and transmitting, by the management device, the generated common key to the respective vehicle-mounted devices that are to attend the session.

One aspect of the present disclosure can be realized not only as a vehicle-mounted relay device including such a characteristic processing unit, but also as a semiconductor integrated circuit that realizes some or all of the vehicle-mounted relay device, as a program for causing a computer to execute steps of processing in the vehicle-mounted relay device, as a semiconductor integrated circuit that realizes some or all of the vehicle-mounted system including the vehicle-mounted relay device, or as a program for causing a computer to execute steps of processing in the vehicle-mounted system.

One aspect of the present disclosure can be realized not only as a management device including such a characteristic processing unit but also as a semiconductor integrated circuit that realizes some or all of the management device, as a program for causing a computer to execute steps of processing in the management device, as a semiconductor integrated circuit that realizes some or all of the vehicle-mounted system including the management device, or as a program for causing a computer to execute steps of processing in the vehicle-mounted system.

### BRIEF DESCRIPTION OF THE DRAWINGS

FIG. 1 is a diagram showing a configuration of a vehicle-mounted system according to a first embodiment of the present disclosure.

FIG. 2 is a diagram showing an example of an Ethernet frame transmitted and received in the vehicle-mounted system according to the first embodiment of the present disclosure.

FIG. 3 is a diagram showing an example of a SOME/IP-SD message transmitted and received in the vehicle-mounted system according to the first embodiment of the present disclosure.

FIG. 4 is a diagram showing an example of a SOME/IP message transmitted and received in the vehicle-mounted system according to the first embodiment of the present disclosure.

FIG. 5 is a diagram showing a configuration of a vehicle-mounted ECU according to the first embodiment of the present disclosure.

FIG. 6 is a diagram showing a configuration of a relay device according to the first embodiment of the present disclosure.

FIG. 7 is a diagram showing an example of a connection destination list stored in the storage unit in the relay device according to the first embodiment of the present disclosure.

FIG. 8 is a diagram showing an example of an invalid log list in the storage unit in the relay device according to the first embodiment of the present disclosure.

FIG. 9 is a diagram showing an example of a session log list in the storage unit in the relay device according to the first embodiment of the present disclosure.

FIG. 10 is a diagram showing an example of a session between a server and a client in the vehicle-mounted system according to the first embodiment of the present disclosure.

FIG. 11 is a flowchart defining an example of an operation procedure when the relay device distributes a session key according to the first embodiment of the present disclosure.

FIG. 12 is a flowchart defining an example of an operation procedure when the relay device distributes a session key according to the first embodiment of the present disclosure.

FIG. 13 is a diagram showing an example of a sequence of communication in the vehicle-mounted system according to the first embodiment of the present disclosure.

FIG. 14 is a diagram showing another example of a sequence of communication in the vehicle-mounted system according to the first embodiment of the present disclosure.

FIG. 15 is a diagram showing a configuration of a vehicle-mounted system according to a second embodiment of the present disclosure.

FIG. 16 is a diagram showing a configuration of a management device according to the second embodiment of the present disclosure.

FIG. 17 is a flowchart defining an example of an operation procedure when the management device distributes a session key according to the second embodiment of the present disclosure.

FIG. 18 is a diagram showing an example of a sequence of communication in the vehicle-mounted system according to the second embodiment of the present disclosure.

FIG. 19 is a diagram showing another example of a sequence of communication in the vehicle-mounted system according to the second embodiment of the present disclosure.

### DETAILED DESCRIPTION

Conventionally, techniques for improving security in a vehicle-mounted network have been developed.

### Problems to be Solved by Present Disclosure

The frame transmission blocking device described in PTL 1 detects an invalid (unauthorized) message based on a content of a data frame, that is, a message, transmitted and received in an electronic control unit (ECU) and a transmission and reception cycle of the message.

In recent years, vehicle-mounted systems that perform service-oriented communication have been developed. In such vehicle-mounted systems, unexpected messages and messages containing no payload are transmitted and received. The frame transmission blocking device described in PTL 1 has a problem in that it is difficult to detect an invalid message in a vehicle-mounted system in which an unexpected message and a message containing no payload are transmitted and received.

The present disclosure has been made in order to solve the above-described problems, and an object of the present disclosure is to provide a vehicle-mounted relay device, a management device, a vehicle-mounted system, and a communication management method that are capable of further improving security in a vehicle-mounted network.

### Advantageous Effects of Present Disclosure

According to the present disclosure, security in a vehicle-mounted network can be further improved.

### Description of Embodiments of Present Disclosure

First, the contents of embodiments of the present disclosure will be listed and explained.

(1) A vehicle-mounted relay device according to an embodiment of the present disclosure includes a relay unit configured to perform relay processing of transmitting each of a plurality of frames received from a corresponding one of a plurality of vehicle-mounted devices to a corresponding one of the plurality of vehicle-mounted devices serving as destinations; a determination unit configured to determine that the plurality of frames include a start-request for starting a session of communication between the plurality of vehicle-mounted devices and that the plurality of frames include a start-response to the start-request; a generation unit configured to generate, on a session-by-session basis, a common key to be used in the session attended by, among the plurality of vehicle-mounted devices, a vehicle-mounted device serving as a source of the frame determined to include the start-request by the determination unit and one or more vehicle-mounted devices serving as a source of the frame determined to include the start-response by the determination unit; and a transmission unit configured to transmit the common key via the relay unit to the respective vehicle-mounted devices that are to attend the session.

As described above, with the configuration in which the vehicle-mounted relay device determines that the received frame includes a start-request and that the received frame includes a start-response, generates, on a session-by-session basis, a common key to be used in the session attended by, among the plurality of vehicle-mounted devices, a vehicle-mounted device serving as a source of the frame including the start-request and one or more vehicle-mounted devices serving as the source of the frame including the start-response, and transmits the common key to the respective vehicle-mounted devices, it is possible to perform communication between the vehicle-mounted devices using the individual common key on a session-by-session basis, thereby improving the security of communication between the vehicle-mounted devices. Further, for example, by generating and transmitting the common key after performing authentication of the vehicle-mounted device serving as the source of the start-request and the vehicle-mounted device serving as the source of the start-response, it is possible to prevent an invalid device from attending the session. Therefore, it is possible to further improve security in the vehicle-mounted network.

(2) The vehicle-mounted relay device may further include a storage unit configured to store unique IDs of the respective vehicle-mounted devices. The transmission unit is configured to transmit the common key, the common key having been encrypted using one of the unique IDs as an encryption key, via the relay unit to the vehicle-mounted device having the unique ID used for encryption.

With this configuration, only a valid vehicle-mounted device that can attend a session can decrypt the common key, so that it is possible, for example, to prevent the leakage of the common key to an invalid vehicle-mounted device.

(3) The transmission unit may be configured to further transmit a hash value, the hash value being calculated using one of the unique IDs and the common key, via the relay unit to the vehicle-mounted device having the unique ID used for calculating the hash value.

With this configuration, the vehicle-mounted device that has received the common key from the vehicle-mounted relay device can confirm whether the common key received from the vehicle-mounted relay device has been tampered with by comparing the hash value received from the vehicle-mounted relay device with a hash value calculated using its own unique ID and common key from the vehicle-mounted relay device.

(4) The vehicle-mounted relay device may further include a recording unit configured to record session information about the session in which the common key is used.

With this configuration, the session information recorded by the vehicle-mounted relay device can be used for, for example, digital forensics. Further, since the session information related to a plurality of sessions can be aggregated in the vehicle-mounted relay device without providing the respective vehicle-mounted devices with a function of storing the session information, for example, the session information related to all the sessions started in the vehicle-mounted system can be recorded with a simple configuration.

(5) The recording unit may be configured to record, as the session information, a time at which the common key is transmitted by the relay unit.

With this configuration, the vehicle-mounted relay device can record the start of the session.

(6) The determination unit may be configured to determine that one of the plurality of frames received by the relay unit includes an end-request for ending the session, and the recording unit is configured to record, as the session information, a time at which the frame including the end-request is received by the relay unit.

With this configuration, the vehicle-mounted relay device can record the end of the session.

(7) The determination unit may be configured to, in accordance with a determination result indicating that one of the plurality of frames received by the relay unit includes the start-request or the start-response, determine whether the frame is appropriate or inappropriate, and the relay unit is configured to, in accordance with a determination result of the determination unit indicating whether the frame is appropriate or inappropriate, perform the relay processing or discarding of the frame.

With this configuration, it is possible to detect a start-request and a start-response from an invalid device and prevent the invalid device from attending the session.

(8) A management device according to an embodiment of present disclosure used in a vehicle-mounted system including a plurality of vehicle-mounted devices, the management device includes a reception unit configured to receive a start-request for starting a session of communication between multiple vehicle-mounted devices which are some or all of the plurality of vehicle-mounted devices, and a start-response to the start-request, the start-request and the start-response each being received from a corresponding one of the multiple vehicle-mounted devices; a generation unit configured to generate a common key, the common key being to be used in the session associated with the start-request and the start-response and being unique to the session; and a transmission unit configured to transmit the common key to the respective vehicle-mounted devices that are to attend the session.

As described above, with the configuration in which the start-request and the start-response of the session are received from the vehicle-mounted device, and the common key used in the session and unique to the session is generated and transmitted to the respective vehicle-mounted devices, it is possible to perform communication between the vehicle-mounted devices using the individual common key on a session-by-session basis, thereby improving the security of communication between the vehicle-mounted devices. In addition, for example, a start-request from an invalid device can be detected by authenticating the vehicle-mounted device serving as the source of the start-request. Therefore, it is possible to further improve security in the vehicle-mounted network.

(9) The management device may further include a storage unit configured to store unique IDs of the respective vehicle-mounted devices. The transmission unit may be configured to transmit the common key, the common key having been encrypted using one of the unique IDs as an encryption key, to the vehicle-mounted device having the unique ID used for encryption.

With this configuration, only a valid vehicle-mounted device that can attend the session can decrypt the common key, so that it is possible, for example to prevent the leakage of the common key to an invalid vehicle-mounted device.

(10) The transmission unit may be configured to further transmit a hash value, the hash value being calculated using one of the unique IDs and the common key, to the vehicle-mounted device having the unique ID used for calculating the hash value.

With this configuration, the vehicle-mounted device that has received the common key from the management device can confirm whether the common key received from the vehicle-mounted relay device has been tampered with by comparing the hash value received from the management device with a hash value calculated using its own unique ID and common key from the management device.

(11) The reception unit may be configured to receive an end-request for ending the session from one of the multiple vehicle-mounted devices, and the transmission unit is configured to, in response to receipt of the end-request by the reception unit, transmit an end instruction to end the session to another or others of the multiple vehicle-mounted devices attending the session.

With this configuration, since the management device is involved in the end of the session and can record the vehicle-mounted device serving as the source of the end-request and the end time of the session, the recorded information can be used for digital forensics, for example.

(12) The management device may further include a recording unit configured to record session information about the session in which the common key is used.

With this configuration, the session information recorded by the management device can be used for digital forensics, for example. Further, since the session information related to a plurality of sessions can be aggregated in the management device without providing the respective vehicle-mounted devices with a function of storing the session information, for example, the session information related to all the sessions started in the vehicle-mounted system can be recorded with a simple configuration.

(13) The recording unit may be configured to record, as the session information, a time at which the common key is transmitted by the transmission unit.

With this configuration, the management device can record the start of the session.

(14) The management device may further include a recording unit configured to record session information about the session in which the common key is used. The recording unit may be configured to record, as the session information, a time at which the end-request is received by the reception unit.

With this configuration, the management device can be involved in the end of the session and record the end of the session.

(15) A vehicle-mounted system according to an embodiment of the present disclosure includes a plurality of vehicle-mounted devices including a first vehicle-mounted device and a second vehicle-mounted device; and a vehicle-mounted relay device. The vehicle-mounted relay device is configured to perform relay processing of transmitting each of a plurality of frames received from a corresponding one of the plurality of vehicle-mounted devices to a corresponding one of the plurality of vehicle-mounted devices serving as destinations. The first vehicle-mounted device is configured to transmit, to the vehicle-mounted relay device, a first frame including a start-request for starting a session of communication between multiple vehicle-mounted devices which are some or all of the plurality of vehicle-mounted devices. The second vehicle-mounted device is configured to transmit, to the vehicle-mounted relay device, a second frame including a start-response to the start-request. The vehicle-mounted relay device is configured to generate, on a session-by-session basis, a common key to be used in the session attended by the first vehicle-mounted device serving as a source of the first frame that has been received and the second vehicle-mounted device serving as a source of the second frame that has been received, and transmit the generated common key to the respective vehicle-mounted devices that are to attend the session.

As described above, with the configuration in which the first vehicle-mounted device transmits a start-request to the vehicle-mounted relay device, the second vehicle-mounted device transmits a start-response to the vehicle-mounted relay device, and the vehicle-mounted relay device generates a common key used in the session in which the first vehicle-mounted device and the second vehicle-mounted device attend on a session-by-session basis and transmits the common key to the respective vehicle-mounted devices, it is possible to perform communication between the vehicle-mounted devices using the individual common key on a session-by-session basis, thereby improving the security of communication between the vehicle-mounted devices. Further, for example, by generating and transmitting the common key after performing authentication of the vehicle-mounted device serving as the source of the start-request and the vehicle-mounted device serving as the source of the start-response, it is possible to prevent an invalid device from attending the session. Therefore, it is possible to further improve security in the vehicle-mounted network.

(16) The vehicle-mounted relay device may be connected to the first vehicle-mounted device and the second vehicle-mounted device without via another relay device.

With this configuration, since the vehicle-mounted relay device can receive the frame transmitted by the first vehicle-mounted device and the frame transmitted by the second vehicle-mounted device, it is possible to easily generate and transmit the common key of the session attended by the first vehicle-mounted device and the second vehicle-mounted device.

(17) Each of the plurality of vehicle-mounted devices may be configured to, in response to detecting abnormality in the vehicle-mounted system in a state of transmitting information to the plurality of vehicle-mounted devices by multicasting, change the state to a state of transmitting information to the plurality of vehicle-mounted devices by unicasting.

With this configuration, in a case where an abnormality such as intrusion of an invalid device occurs in the vehicle-mounted system, for example, it is possible to maintain a state in which safe communication is possible at least between authorized vehicle-mounted devices.

(18) The vehicle-mounted relay device may include a storage unit configured to store unique IDs of the respective vehicle-mounted devices in the vehicle-mounted system. The vehicle-mounted relay device may be configured to further transmit a hash value, the hash value being calculated using one of the unique IDs and the common key, to the vehicle-mounted device having the unique ID used for calculating the hash value. The vehicle-mounted device may be configured to compare the hash value received from the vehicle-mounted relay device with a hash value calculated using the common key received from the vehicle-mounted relay device and the unique ID of the vehicle-mounted device.

With this configuration, in the vehicle-mounted device, it is possible to confirm whether the common key received from the vehicle-mounted relay device has been tampered with based on the comparison result between the calculated hash value and the hash value received from the vehicle-mounted relay device.

(19) A vehicle-mounted system according to an embodiment of the present disclosure includes a plurality of vehicle-mounted devices including a first vehicle-mounted device and a second vehicle-mounted device; and a management device. The first vehicle-mounted device is configured to transmit, to the management device, a start-request for starting a session of communication between multiple vehicle-mounted devices which are some or all of the plurality of vehicle-mounted devices, the second vehicle-mounted device is configured to transmit, to the management device, a start-response to the start-request, and the management device is configured to generate a common key, the common key being to be used in the session associated with the start-request and the start-response that have been received and being unique to the session, and transmit the generated common key to the respective vehicle-mounted devices that are to attend the session.

As described above, with the configuration in which the first vehicle-mounted device transmits a start-request of a session to the management device, the second vehicle-mounted device transmits a start-response to the start-request to the management device, and the management device generates a common key used in the session and unique to the session and transmits to the respective vehicle-mounted devices, it is possible to perform communication between the vehicle-mounted devices using the individual common key on a session-by-session basis, thereby improving the security of communication between the vehicle-mounted devices. In addition, for example, a start-request from an invalid device can be detected by authenticating the vehicle-mounted device serving as the source of the start-request. Therefore, it is possible to further improve security in the vehicle-mounted network.

(20) Each of the plurality of vehicle-mounted devices may be configured to, in response to detecting abnormality in the vehicle-mounted system in a state of transmitting information to the plurality of vehicle-mounted devices by multicasting, change the state to a state of transmitting information to the plurality of vehicle-mounted devices by unicasting.

With this configuration, in a case where an abnormality such as intrusion of an invalid device occurs in the vehicle-mounted system, for example, it is possible to maintain a state in which safe communication is possible at least between authorized vehicle-mounted devices.

(21) The management device may include a storage unit configured to store unique IDs of the respective vehicle-mounted devices in the vehicle-mounted system. The management device may be configured to further transmit a hash value, the hash value being calculated using one of the unique IDs and the common key, to the vehicle-mounted device having the unique ID used for calculating the hash value. The vehicle-mounted device may be configured to compare the hash value received from the management device with a hash value calculated using the common key received from the management device and the unique ID of the vehicle-mounted device.

With this configuration, in the vehicle-mounted device, it is possible to confirm whether the common key received from the management device has been tampered with based on the comparison result between the calculated hash value and the hash value received from the management device.

(22) A communication management method according to an embodiment of present disclosure for a vehicle-mounted relay device configured to perform relay processing of transmitting each of a plurality of frames received from a corresponding one of a plurality of vehicle-mounted devices to a corresponding one of the plurality of vehicle-mounted devices serving as destinations, the communication management method includes determining that the plurality of frames include a start-request for starting a session of communication between the plurality of vehicle-mounted devices and that the plurality of frames include a start-response to the start-request; generating, on a session-by-session basis, a common key to be used in the session attended by, among the plurality of vehicle-mounted devices, a vehicle-mounted device serving as a source of the frame determined to include the start-request and one or more vehicle-mounted devices serving as a source of the frame determined to include the start-response; and transmitting the generated common key to the respective vehicle-mounted devices that are to attend the session.

As described above, by the method in which the vehicle-mounted relay device determines that the received frame includes a start-request and that the received frame includes a start-response, generates, on a session-by-session basis, a common key to be used in the session attended by, among the plurality of vehicle-mounted devices, a vehicle-mounted device serving as a source of the frame including the start-request and one or more vehicle-mounted devices serving as a source of the frame including the start-response, and transmits the common key to the respective vehicle-mounted devices, it is possible to perform communication between the vehicle-mounted devices using the individual common key on a session-by-session basis, thereby improving the security of communication between the vehicle-mounted devices. Further, for example, by generating and transmitting the common key after performing authentication of the vehicle-mounted device serving as the source of the start-request and the vehicle-mounted device serving as the source of the start-response, it is possible to prevent an invalid device from attending the session. Therefore, it is possible to further improve security in the vehicle-mounted network.

(23) A communication management method according to an embodiment of the present disclosure for a management device used in a vehicle-mounted system including a plurality of vehicle-mounted devices, the communication management method includes receiving a start-request for starting a session of communication between multiple vehicle-mounted devices which are some or all of the plurality of vehicle-mounted devices, and a start-response to the start-request, the start-request and the start-response each being received from a corresponding one of the multiple vehicle-mounted devices; generating a common key, the common key being to be used in the session associated with the received start-request and start-response and being unique to the session; and transmitting the generated common key to the respective vehicle-mounted devices that are to attend the session.

As described above, by the method in which the start-request and the start-response of the session are received from the vehicle-mounted device, and the common key used in the session and unique to the session is generated and transmitted to the respective vehicle-mounted devices, it is possible to perform communication between the vehicle-mounted devices using the individual common key on a session-by-session basis, thereby improving the security of communication between the vehicle-mounted devices. In addition, for example, a start-request from an invalid device can be detected by authenticating the vehicle-mounted device serving as the source of the start-request. Therefore, it is possible to further improve security in the vehicle-mounted network.

(24) A communication management method according to an embodiment of the present disclosure for a vehicle-mounted system including a plurality of vehicle-mounted devices including a first vehicle-mounted device and a second vehicle-mounted device, and a vehicle-mounted relay device configured to perform relay processing of transmitting each of a plurality of frames received from a corresponding one of the plurality of vehicle-mounted devices to a corresponding one of the plurality of vehicle-mounted devices serving as destinations, the communication management method includes transmitting, by the first vehicle-mounted device, to the vehicle-mounted relay device, a first frame including a start-request for starting a session of communication between multiple vehicle-mounted devices which are some or all of the plurality of vehicle-mounted devices; transmitting, by the second vehicle-mounted device, to the vehicle-mounted relay device, a second frame including a start-response to the start-request; and generating, by the vehicle-mounted relay device, on a session-by-session basis, a common key to be used in the session attended by the first vehicle-mounted device serving as a source of the first frame that has been received and the second vehicle-mounted device serving as a source of the second frame that has been received, and transmitting, by the vehicle-mounted relay device, the generated common key to the respective vehicle-mounted devices that are to attend the session.

As described above, by the method in which the first vehicle-mounted device transmits a start-request to the vehicle-mounted relay device, the second vehicle-mounted device transmits a start-response to the vehicle-mounted relay device, and the vehicle-mounted relay device generates, on a session-by-session basis, a common key to be used in the session in which the first vehicle-mounted device and the second vehicle-mounted device attend and transmits the common key to the respective vehicle-mounted devices, it is possible to perform communication between the vehicle-mounted devices using the individual common key on a session-by-session basis, thereby improving the security of communication between the vehicle-mounted devices. Further, for example, by generating and transmitting the common key after performing authentication of the vehicle-mounted device serving as the source of the start-request and the vehicle-mounted device serving as the source of the start-response, it is possible to prevent an invalid device from attending the session. Therefore, it is possible to further improve security in the vehicle-mounted network.

(25) A communication management method according to an embodiment of the present disclosure for a vehicle-mounted system including a plurality of vehicle-mounted devices including a first vehicle-mounted device and a second vehicle-mounted device, and a management device, the communication management method includes transmitting, by the first vehicle-mounted device, to the management device, a start-request for starting a session of communication between multiple vehicle-mounted devices which are some or all of the plurality of vehicle-mounted devices; transmitting, by the second vehicle-mounted device, to the management device, a start-response to the start-request; and generating, by the management device, a common key, the common key being to be used in the session associated with the start-request and the start-response that have been received and being unique to the session, and transmitting, by the management device, the generated common key to the respective vehicle-mounted devices that are to attend the session.

As described above, by the method in which the first vehicle-mounted device transmits a start-request of a session to the management device, the second vehicle-mounted device transmits a start-response to the start-request to the management device, and the management device generates a common key used in the session and unique to the session and transmitted to the respective vehicle-mounted devices, it is possible to perform communication between the vehicle-mounted devices using the individual common key on a session-by-session basis, thereby improving the security of communication between the vehicle-mounted devices. In addition, for example, a start-request from an invalid device can be detected by authenticating the vehicle-mounted device serving as the source of the start-request. Therefore, it is possible to further improve security in the vehicle-mounted network.

Hereinafter, embodiments of the present disclosure will be described with reference to the drawings. Note that the same or corresponding parts in the drawings are denoted by the same reference numerals, and description thereof will not be repeated. Further, at least some of the embodiments described below may be arbitrarily combined.

### First Embodiment

### [Configuration and Basic Operation]

### <Vehicle-Mounted System>

FIG. 1 is a diagram showing a configuration of a vehicle-mounted system according to a first embodiment of the present disclosure. Referring to FIG. 1, a vehicle-mounted system 301 includes a relay device 101 and a plurality of vehicle-mounted ECUs 111. Relay device 101 is an example of a vehicle-mounted relay device. Vehicle-mounted ECU 111 is an example of a vehicle-mounted device. Vehicle-mounted system 301 is mounted on a vehicle 1. Relay device 101 is used in vehicle-mounted system 301.

Relay device 101 is connected to each vehicle-mounted ECU 111 via a cable 14. For example, relay device 101 and vehicle-mounted ECU 111 are connected to each other not via another relay device. Cable 14 is, for example, an Ethernet (registered trademark) cable. Relay device 101 and vehicle-mounted ECU 111 constitute a vehicle-mounted network.

Vehicle-mounted ECU 111 is, for example, an electric power steering (EPS), a brake control device, an accelerator control device, a steering control device, a driving assistance device that gives instructions to various devices in an advanced driver-assistance system (ADAS), a sensor, or the like.

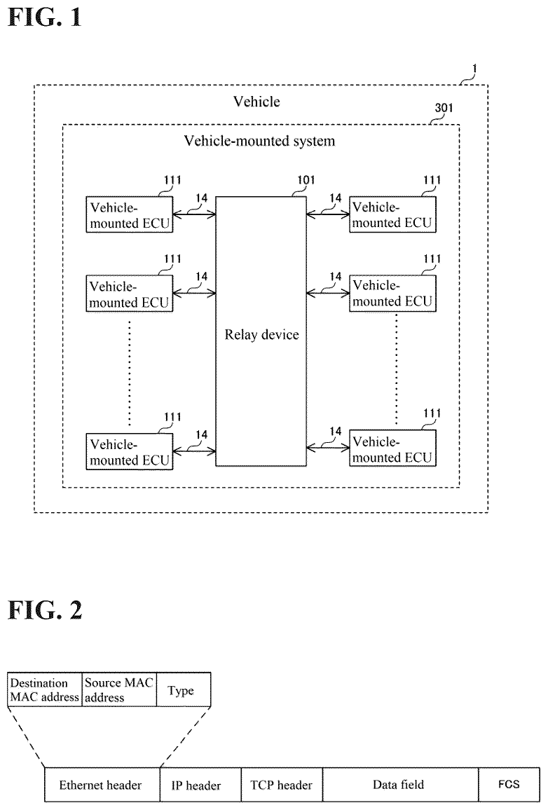

FIG. 2 is a diagram showing an example of an Ethernet frame transmitted and received in the vehicle-mounted system according to the first embodiment of the present disclosure. Referring to FIG. 2, the Ethernet frame includes an Ethernet header, an IP (Internet Protocol) header, a TCP (Transmission Control Protocol) header, a data field, and an FCS (Frame Check Sequence). In the Ethernet header, a destination media access control (MAC) address, a source MAC address, and a type are stored.

Vehicle-mounted ECU 111 generates an Ethernet frame addressed to another vehicle-mounted ECU 111 and transmits the generated Ethernet frame to relay device 101.

Relay device 101 can communicate with vehicle-mounted ECU 111. Relay device 101 performs relay processing for transmitting the Ethernet frame received from vehicle-mounted ECU 111 to another vehicle-mounted ECU 111. For example, relay device 101 performs the relay processing according to a layer 2. Note that relay device 101 may be configured to perform the relay processing in accordance with a layer 3 that is higher than layer 2.

### (SOME/IP)

In vehicle-mounted system 301, messages are transmitted and received in accordance with, for example, SOME/IP (Scalable service-Oriented MiddlewarE over IP) which is a protocol of a layer equal to or higher than a session layer in an Internet protocol group. More specifically, vehicle-mounted ECU 111 stores a message in which various kinds of information are stored in a data field of an Ethernet frame, and transmits the Ethernet frame to another vehicle-mounted ECU 111 via relay device 101 according to SOME/IP.

For example, vehicle-mounted ECU 111 starts a session of communication between the plurality of vehicle-mounted ECUs 111. The plurality of vehicle-mounted ECU 111 attending the session transmit and receive messages. The combination of vehicle-mounted ECU 111 attending the session is not fixed but dynamically changes.

As an example, a sensor which is vehicle-mounted ECU 111 and the driving assistance device that is another vehicle-mounted ECU 111 start a session. In this case, the sensor stores sensor information related to the traveling state of vehicle 1 or the surrounding state into a message and transmits the message to the driving support apparatus as the provision of the service. The driving assistance device acquires sensor information provided as a service from the received message, generates various types of control information related to driving of vehicle 1 using the sensor information, and transmits the generated various types of control information to the brake control device, the steering control device, and the like.

Hereinafter, vehicle-mounted ECU 111 that provides the service is also referred to as a “server”. Vehicle-mounted ECU 111 that receives the provision of the service is also referred to as a “client”. Vehicle-mounted ECU 111 may function only as a server, may function only as a client, or may function as a server or a client depending on the content of a service in the session. The server is an example of a first vehicle-mounted device. The client is an example of a second vehicle-mounted device.

### (A) Start of Session

In communication according to SOME/IP, the session starts when Service Discovery is executed. More specifically, the plurality of vehicle-mounted ECUs 111 start the session by transmitting and receiving a SOME/IP-SD message.

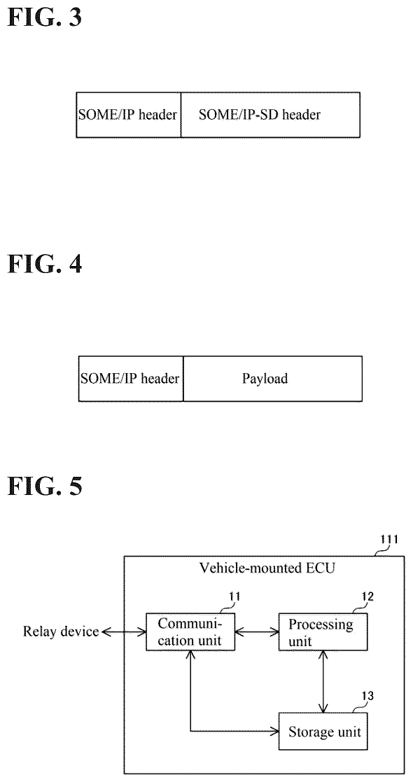

FIG. 3 is a diagram showing an example of a SOME/IP-SD message transmitted and received in the vehicle-mounted system according to the first embodiment of the present disclosure. Referring to FIG. 3, the SOME/IP-SD message has a SOME/IP header and a SOME/IP-SD header.

### (A-1) Offer Message

As an example, by the function of Service Discovery, the server offers the provision of the service, and the session between the client and the server starts.

For example, a certain vehicle-mounted ECU 111 multicasts, as a server, an Offer message, which is an example of a SOME/IP-SD message, regularly or irregularly. More specifically, the server generates an Offer message in which a service ID corresponding to a service that can be provided by the server is stored in the SOME/IP-SD header. Then, the server generates an Ethernet frame in which the Offer message is stored in the data field and the multicasting address is stored as the destination MAC address, and transmits the generated Ethernet frame to relay device 101. The Offer message is an example of a start-request of the session.

Among the plurality of vehicle-mounted ECUs 111 that have received the Offer message from the server via relay device 101, vehicle-mounted ECU 111 that requires the service corresponding to the service ID included in the Offer message transmits, as a client, a Subscribe message, which is an example of the SOME/IP-SD message, to the server via relay device 101. More specifically, the client generates an Ethernet frame in which the Subscribe message is stored in the data field, and transmits the generated Ethernet frame to the server via relay device 101. The Subscribe message is an example of a start-response to the start-request of the session.

After receiving the Subscribe message from the client via relay device 101, the server starts providing the service to the client.

### (A-2) Find Message

As another example, by the function of Service Discovery, a client searches for a server that is a service providing source, and the session of communication between the client and the server is started.

For example, a certain vehicle-mounted ECU 111 multicasts, as a client, a Find message, which is an example of a SOME/IP-SD message, regularly or irregularly. More specifically, the client generates a Find message in which a service ID corresponding to a service to be provided is stored in the SOME/IP-SD header. Then, the client generates an Ethernet frame in which the Find message is stored in the data field and the multicasting address is stored as the destination MAC address, and transmits the generated Ethernet frame to relay device 101. The Find message is an example of a search-request for the session.

Among the plurality of vehicle-mounted ECUs 111 that have received the Find message from the client via relay device 101, vehicle-mounted ECU 111 that can provide the service corresponding to the service ID included in the Find message serves as the server and transmits an Offer message, which is an example of the SOME/IP-SD message, to the client via relay device 101. More specifically, the server generates an Ethernet frame in which the Offer message is stored in the data field, and transmits the generated Ethernet frame to the client via relay device 101. The Offer message is an example of a start-request to a search-request for the session.

After receiving the Offer message from the server via relay device 101, the client transmits a Subscribe message, which is an example of the SOME/IP-SD message, to the server via relay device 101. More specifically, the client generates an Ethernet frame in which the Subscribe message is stored in the data field, and transmits the generated Ethernet frame to the server via relay device 101. The Subscribe message is an example of a start-response to a start-request of the session.

After receiving the Subscribe message from the client via relay device 101, the server starts providing the service to the client.

### (B) Communication in Session

In communication according to SOME/IP, in the session between a server and a client, a SOME/IP message is transmitted from the server to the client.

FIG. 4 is a diagram showing an example of a SOME/IP message transmitted and received in the vehicle-mounted system according to the first embodiment of the present disclosure. Referring to FIG. 4, the SOME/IP message has a SOME/IP header and a payload.

For example, the server regularly or irregularly transmits a session message, which is an example of the SOME/IP message, to the client via relay device 101. More specifically, the server generates the session message in which information to be provided as a service is stored in a payload. Then, the server generates an Ethernet frame in which the session message is stored in the data field, and transmits the generated Ethernet frame to the client via relay device 101.

### (C) End of Session

In the communication according to SOME/IP, the session is ended by executing Service Discovery. More specifically, the plurality of vehicle-mounted ECUs 111 end the session by transmitting and receiving the SOME/IP-SD message.

### (C-1) StopOffer Message

As an example, by the function of Service Discovery, the server offers to stop providing the service, and the session ends.

For example, when the server stops providing the service, the server transmits a StopOffer message which is an example of the SOME/IP-SD message to the client. More specifically, the server generates the StopOffer message in which the service ID corresponding to the service whose provision is to be stopped is stored in the SOME/IP-SD header. Then, the server generates an Ethernet frame in which the StopOffer message is stored in data field and transmits the generated Ethernet frame to the client via relay device 101. The StopOffer message is an example of an end-request of the session.

After transmitting the StopOffer message to the client via relay device 101, the server ends providing the service to the client.

### (C-2) StopSubscribe Message

As another example, by the function of Service Discovery, the client offers to stop receiving the service, and the session ends.

For example, when the client stops receiving the service, the client transmits a StopSubscribe message which is an example of the SOME/IP-SD message to the server. More specifically, the client generates the StopSubscribe message in which the service ID corresponding to the service whose receiving is to be stopped is stored in the SOME/IP-SD header. Then, the client generates an Ethernet frame in which the StopSubscribe message is stored in data field and transmits the generated Ethernet frame to the server via relay device 101. The StopSubscribe message is an example of an end-request of the session.

After receiving the Subscribe message from the client via relay device 101, the server ends providing the service to the client.

### <Outline of Processing in Vehicle-Mounted ECU and Relay Device>

FIG. 5 is a diagram showing a configuration of a vehicle-mounted ECU according to the first embodiment of the present disclosure. Referring to FIG. 5, vehicle-mounted ECU 111 includes a communication unit 11, a processing unit 12, and a storage unit 13. Communication unit 11 and processing unit 12 are realized by processors such as a central processing unit (CPU) and a digital signal processor (DSP), for example. Storage unit 13 is, for example, a nonvolatile memory.

Storage unit 13 in vehicle-mounted ECU 111 stores the unique ID of vehicle-mounted ECU 111, the ECU identifier that is the identifier of vehicle-mounted ECU 111, the endpoint information of vehicle-mounted ECU 111, and the endpoint information of relay device 101. The unique ID is written in storage unit 13 when vehicle 1 is shipped, for example. The unique ID has higher confidentiality than the ECU identifier. The endpoint information includes an IP address and a logical port number.

Storage unit 13 stores a service list indicating a correspondence relationship between the content of the service provided in vehicle-mounted system 301 and the service ID.

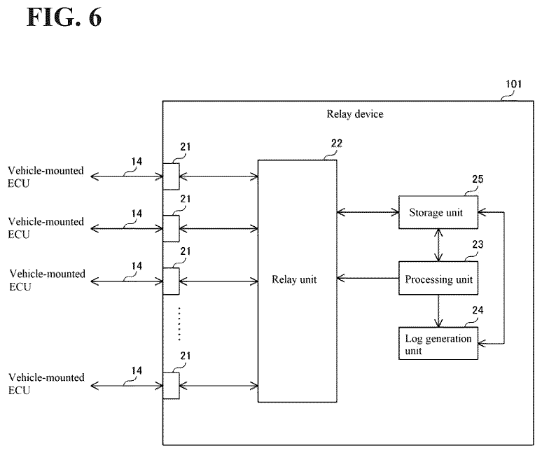

FIG. 6 is a diagram showing a configuration of a relay device according to the first embodiment of the present disclosure. Referring to FIG. 6, relay device 101 includes a plurality of communication ports 21, a relay unit 22, a processing unit 23, a log generation unit 24, and a storage unit 25. Processing unit 23 is an example of a determination unit, an example of a generation unit, and an example of a transmission unit. Log generation unit 24 is an example of a recording unit. Relay unit 22, processing unit 23, and log generation unit 24 are realized by processors such as a CPU and a DSP, for example. Storage unit 25 is, for example, a nonvolatile memory.

Communication port 21 is a terminal to which cable 14 can be connected. Communication port 21 is connected to vehicle-mounted ECU 111 via cable 14. Note that communication port 21 may be a terminal of an integrated circuit.

Storage unit 25 stores an address table Tb 1 indicating a correspondence relationship between the port number of communication port 21 and the MAC address of vehicle-mounted ECU 111 connected to communication port 21.

Storage unit 25 also stores the unique ID of each vehicle-mounted ECU 111 in vehicle-mounted system 301. For example, storage unit 25 stores, for each service ID, a connection destination list, which indicates endpoint information, an ECU identifier, and a unique ID of a server and a client that can be involved in the service.

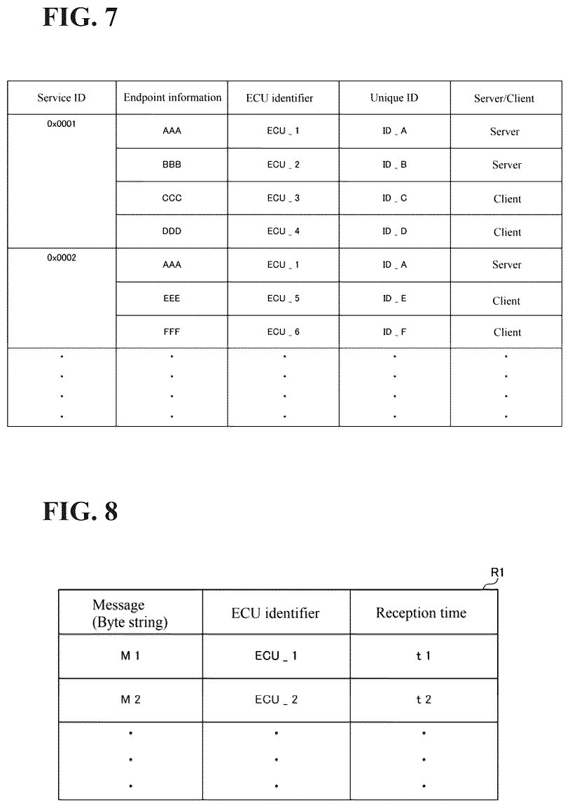

FIG. 7 is a diagram showing an example of the connection destination list stored in the storage unit in the relay device according to the first embodiment of the present disclosure. Referring to FIG. 7, the endpoint information and the like of two servers and two clients that can be involved in the service whose service ID is “0x0001” and the endpoint information and the like of one server and two clients that can be involved in the service whose service ID is “0x0002” are registered in the connection destination list. More specifically, vehicle-mounted ECU 111 whose endpoint information is “AAA”, whose ECU identifier is “ECU_1”, and whose unique ID is “ID A” is registered in the connection destination list as a server that can be involved in the service whose service ID is “0x0002”. Here, the number beginning with “0x” means that the number after “0x” is expressed in hexadecimal.

Relay unit 22 performs the relay processing for transmitting the plurality of Ethernet frames received respectively from the plurality of vehicle-mounted ECU 111 to vehicle-mounted ECU 111 serving as destinations respectively. As will be described later, relay unit 22 may discard the received Ethernet frame without relaying it to vehicle-mounted ECU 111 serving as destinations in response to an instruction from processing unit 23.

More specifically, when relay unit 22 receives an Ethernet frame from a certain vehicle-mounted ECU 111 via corresponding communication port 21, relay unit 22 stores the received Ethernet frame in storage unit 25.

Processing unit 23 determines whether the Ethernet frame received by relay unit 22 includes the SOME/IP-SD message. For example, when the Ethernet frame is stored in storage unit 25 by relay unit 22, processing unit 23 confirms whether the SOME/IP-SD header is included in the data field of the corresponding Ethernet frame.

When the SOME/IP-SD header is not included in the data field of the Ethernet frame stored in storage unit 25 by relay unit 22, processing unit 23 determines that the Ethernet frame does not include the SOME/IP-SD message, and outputs a relay instruction indicating that the relay processing of the Ethernet frame should be performed to relay unit 22.

When receiving the relay instruction from processing unit 23, relay unit 22 acquires the Ethernet frame indicated by the relay instruction from storage unit 25 and performs the relay processing of the Ethernet frame. Specifically, relay unit 22 refers to address table Tb 1 in storage unit 25 and transmits the Ethernet frame to vehicle-mounted ECU 111 serving as destinations via communication port 21 having the port number corresponding to the destination MAC address of the Ethernet frame.

Meanwhile, when the SOME/IP-SD header is included in the data field of the Ethernet frame stored in storage unit 25 by relay unit 22, processing unit 23 determines that the Ethernet frame includes the SOME/IP-SD message. Then, processing unit 23 determines that the Ethernet frame includes an Offer message by referring to the SOME/IP-SD header. Alternatively, processing unit 23 determines that the Ethernet frame includes the Find message by referring to the SOME/IP-SD header of the Ethernet frame stored in storage unit 25 by relay unit 22. Alternatively, processing unit 23 determines that the Ethernet frame includes the Subscribe message by referring to the SOME/IP-SD header of the Ethernet frame stored in storage unit 25 by relay unit 22. Alternatively, processing unit 23 determines that the Ethernet frame includes the StopOffer message by referring to the SOME/IP-SD header of the Ethernet frame stored in storage unit 25 by relay unit 22. Alternatively, processing unit 23 determines that the Ethernet frame includes the StopSubscribe message by referring to the SOME/IP-SD header of the Ethernet frame stored in storage unit 25 by relay unit 22.

Further, when processing unit 23 determines that the Ethernet frame stored in storage unit 25 by relay unit 22 includes the SOME/IP-SD message, processing unit 23 determines whether the Ethernet frame is appropriate or inappropriate.

Relay unit 22 performs the relay processing or discarding of the Ethernet frame according to the determination result of the propriety of the Ethernet frame by processing unit 23.

More specifically, when processing unit 23 determines that the Ethernet frame is inappropriate, processing unit 23 outputs a discard-instruction indicating that the Ethernet frame should be discarded to relay unit 22.

When receiving the discard-instruction from processing unit 23, relay unit 22 discards the Ethernet frame indicated by the relay instruction in storage unit 25.

On the other hand, when determining that the Ethernet frame is appropriate, processing unit 23 outputs a relay instruction indicating that the relay processing of the Ethernet frame should be performed to relay unit 22.

When receiving the relay instruction from processing unit 23, relay unit 22 acquires the Ethernet frame indicated by the relay instruction from storage unit 25 and performs the relay processing of the Ethernet frame.

Processing unit 23 generates, on a session-by-session basis, a session key K to be used in the session attended by, among the plurality of vehicle-mounted ECU 111, vehicle-mounted ECU 111 serving as the source of the Ethernet frame determined to include the start-request such as the Offer message and one or more vehicle-mounted ECUs 111 serving as a source of the Ethernet frame determined to include the start-response such as the Subscribe message. Session key K is an example of a common key, and is, for example, a random number having a key length according to an encryption scheme to be used. For example, processing unit 23 generates session key K having random contents on a session-by-session basis.

Processing unit 23 transmits generated session key K to each vehicle-mounted ECU 111 attending the session via relay unit 22. Log generation unit 24 records session information about the session in which session key K generated by processing unit 23 is used.

### (1) Processing Example 1 in Service Discovery

### (1-1) Transmission of Offer Message by Server

Referring back to FIG. 5, in vehicle-mounted ECU 111 as the server, processing unit 12 refers to the service list in storage unit 13 and acquires the service ID corresponding to the service that vehicle-mounted ECU 111 can provide. Further, processing unit 12 acquires the ECU identifier and the endpoint information of vehicle-mounted ECU 111 from storage unit 13. Processing unit 12 generates an Offer message including the acquired service ID, ECU identifier, and endpoint information.

Processing unit 12 calculates a MAC (Message Authentication Code) value based on the generated Offer message and the unique ID in storage unit 13. Processing unit 12 generates an Ethernet frame in which the Offer message and the MAC value are stored in the data field and the multicasting address is stored as the destination MAC address. Processing unit 12 outputs the generated Ethernet frame to communication unit 11.

Communication unit 11 transmits the Ethernet frame received from processing unit 12 to relay device 101.

### (1-2) Determination of Propriety of Offer Message by Relay Device

Referring back to FIG. 6, relay unit 22 in relay device 101 receives the Ethernet frame from the server via the corresponding communication port, adds a time stamp to the received Ethernet frame, and stores the Ethernet frame in storage unit 25.

When the Ethernet frame is stored in storage unit 25 by relay unit 22, processing unit 23 confirms that the SOME/IP-SD header is included in the data field of the Ethernet frame, and determines that the Ethernet frame includes the Offer message by referring to the SOME/IP-SD header. Then, processing unit 23 determines whether the Ethernet frame is appropriate or inappropriate.

More specifically, processing unit 23 acquires the Offer message, the MAC value, and the time stamp from the Ethernet frame. Further, processing unit 23 acquires the service ID, the endpoint information of vehicle-mounted ECU 111, and the ECU identifier from the acquired Offer message. Then, processing unit 23 refers to the connection destination list in storage unit 25 and confirms whether vehicle-mounted ECU 111 specified by the endpoint information and the ECU identifier acquired from the Offer message is registered in the connection destination list as a server that can be involved in the service indicated by the service ID acquired from the Offer message.

As an example, when the service ID, the endpoint information, and the ECU identifier acquired from the Offer message are “0x0001”, “BBB”, and “ECU_2”, respectively, processing unit 23 determines that vehicle-mounted ECU 111 specified by the ECU identifier and the endpoint information is registered in the connection destination list as a server that can be involved in the service indicated by the service ID.

Further, processing unit 23 refers to the connection destination list and acquires the unique ID of vehicle-mounted ECU 111 specified by the endpoint information or the like acquired from the Offer message. Processing unit 23 calculates a MAC value based on the Offer message and the acquired unique ID. Then, processing unit 23 compares the MAC value acquired from the Ethernet frame with the MAC value calculated by itself to determine whether the Ethernet frame has been tampered with.

When processing unit 23 determines that vehicle-mounted ECU 111 specified by the endpoint information or the like acquired from the Offer message is registered in the connection destination list and that the Ethernet frame has not been tampered with, processing unit 23 determines that the Ethernet frame received by relay unit 22 is appropriate. On the other hand, when vehicle-mounted ECU 111 specified by the endpoint information or the like acquired from the Offer message is not registered in the connection destination list, or when processing unit 23 determines that the Ethernet frame has been tampered with, processing unit 23 determines that the Ethernet frame received by relay unit 22 is inappropriate.

When determining that the Ethernet frame is appropriate, processing unit 23 stores the ECU identifier and the endpoint information acquired from the Offer message in storage unit 25 as the server information.

When determining that the Ethernet frame received by relay unit 22 is appropriate, processing unit 23 deletes the ECU identifier and the endpoint information from the Offer message included in the Ethernet frame in storage unit 25. Then, processing unit 23 outputs a relay instruction indicating that the relay processing of the Ethernet frame should be performed to relay unit 22.

When receiving the relay instruction from processing unit 23, relay unit 22 acquires the Ethernet frame indicated by the relay instruction from storage unit 25 and performs the relay processing of the Ethernet frame. Specifically, relay unit 22 transmits the Ethernet frame from which the ECU identifier and the endpoint information are deleted by processing unit 23 to vehicle-mounted ECU 111 other than vehicle-mounted ECU 111 serving as the source of the Ethernet frame in accordance with the multicasting address which is the destination MAC address of the Ethernet frame.

On the other hand, when processing unit 23 determines that the Ethernet frame received by relay unit 22 is inappropriate, processing unit 23 outputs a discard-instruction indicating that the Ethernet frame should be discarded to relay unit 22.

When relay unit 22 receives the discard-instruction from processing unit 23, relay unit 22 discards the Ethernet frame indicated by the discard-instruction.

When processing unit 23 determines that the Ethernet frame received by relay unit 22 is inappropriate, processing unit 23 outputs the Offer message and the time stamp to log generation unit 24. Log generation unit 24 records information about a message included in the Ethernet frame determined to be inappropriate by processing unit 23.

FIG. 8 is a diagram showing an example of the invalid log list in the storage unit in the relay device according to the first embodiment of the present disclosure. Referring to FIG. 8, storage unit 25 stores an invalid log list R1 which is a list of invalid logs indicating a byte string of a message included in an Ethernet frame determined to be inappropriate by processing unit 23, an ECU identifier of vehicle-mounted ECU 111 serving as the source of the Ethernet frame, and a reception time of the Ethernet frame.

Log generation unit 24 receives the Offer message and the time stamp from processing unit 23, acquires the ECU identifier included in the received Offer message, and writes the byte string of the Offer message, the acquired ECU identifier, and the reception time as the invalid log into invalid log list R1 in storage unit 25.

### (1-3) Transmission of Subscribe Message by Client

Referring back to FIG. 5, in vehicle-mounted ECU 111 as the client, processing unit 12 receives the Ethernet frame from relay device 101 via communication unit 11, and acquires the source MAC address and the Offer message from the received Ethernet frame. Further, processing unit 12 acquires the service ID from the acquired Offer message.

Processing unit 12 refers to the service list in storage unit 13 and determines whether the service indicated by the acquired service ID is necessary. When determining that the service is necessary, processing unit 12 acquires the ECU identifier and the endpoint information of vehicle-mounted ECU 111 from storage unit 13, and generates a Subscribe message including the service ID corresponding to the service, the acquired ECU identifier, and the acquired endpoint information. On the other hand, when processing unit 12 determines that the service is unnecessary, processing unit 12 does not generate the Subscribe message.

Processing unit 12 calculates a MAC value based on the generated Subscribe message and the unique ID in storage unit 13. Processing unit 12 generates an Ethernet frame in which the Subscribe message and the MAC value are stored in the data field and the MAC address of the server is stored as the destination MAC address. Processing unit 12 outputs the generated Ethernet frame to communication unit 11.

Communication unit 11 transmits the Ethernet frame received from processing unit 12 to relay device 101.

### (1-4) Determination of Propriety of Subscribe Message by Relay Device

Referring back to FIG. 6, relay unit 22 in relay device 101 receives the Ethernet frame from the client via the corresponding communication port, adds a time stamp to the received Ethernet frame, and stores the Ethernet frame in storage unit 25.

When the Ethernet frame is stored in storage unit 25 by relay unit 22, processing unit 23 confirms that the SOME/IP-SD header is included in the data field of the Ethernet frame, and determines that the Ethernet frame includes the Subscribe message by referring to the SOME/IP-SD header. Then, processing unit 23 determines whether the Ethernet frame is appropriate or inappropriate.

More specifically, processing unit 23 acquires the Subscribe message, the MAC value, and the time stamp from the Ethernet frame. In addition, processing unit 23 acquires the service ID, the endpoint information of vehicle-mounted ECU 111, and the ECU identifier from the acquired Subscribe message. Then, processing unit 23 refers to the connection destination list in storage unit 25 and confirms whether vehicle-mounted ECU 111 specified by the endpoint information and the ECU identifier acquired from the Subscribe message is registered in the connection destination list as a client that can be involved in the service indicated by the service ID acquired from the Subscribe message.

As an example, when the service ID, the endpoint information, and the ECU identifier acquired from the Subscribe message are “0x0001”, “CCC”, and “ECU_3”, respectively, processing unit 23 determines that vehicle-mounted ECU 111 specified by the ECU identifier and the endpoint information is registered in the connection destination list as a client that can be involved in the service indicated by the service ID.

Further, processing unit 23 refers to the connection destination list and acquires the unique ID of vehicle-mounted ECU 111 specified by the endpoint information or the like acquired from the Subscribe message. Processing unit 23 calculates a MAC value based on the Subscribe message and the acquired unique ID. Then, processing unit 23 compares the MAC value acquired from the Ethernet frame with the MAC value calculated by itself to determine whether the Ethernet frame has been tampered with.

When processing unit 23 determines that vehicle-mounted ECU 111 specified by the endpoint information or the like acquired from the Subscribe message is registered in the connection destination list and that the Ethernet frame has not been tampered with, processing unit 23 determines that the Ethernet frame received by relay unit 22 is appropriate. On the other hand, when vehicle-mounted ECU 111 specified by the endpoint information or the like acquired from the Subscribe message is not registered in the connection destination list, or when processing unit 23 determines that the Ethernet frame has been tampered with, processing unit 23 determines that the Ethernet frame received by relay unit 22 is inappropriate.

When determining that the Ethernet frame is appropriate, processing unit 23 stores the ECU identifier and the endpoint information acquired from the Subscribe message in storage unit 25 as the client information.

On the other hand, when processing unit 23 determines that the Ethernet frame received by relay unit 22 is inappropriate, processing unit 23 outputs a discard-instruction indicating that the Ethernet frame should be discarded to relay unit 22.

When relay unit 22 receives the discard-instruction from processing unit 23, relay unit 22 discards the Ethernet frame indicated by the discard-instruction.

When processing unit 23 determines that the Ethernet frame received by relay unit 22 is inappropriate, processing unit 23 outputs the Subscribe message and the time stamp to log generation unit 24. Log generation unit 24 writes information on the message included in the Ethernet frame determined to be inappropriate by processing unit 23 into invalid log list R1 in storage unit 25.

### (1-5) Generation and Distribution of Session Key by Relay Device

When processing unit 23 in relay device 101 determines that the Ethernet frame in which the Subscribe message is stored is appropriate and stores the client information in storage unit 25, processing unit 23 determines to establish the session between the server and the client indicated respectively by the server information and the client information stored in storage unit 25.

Then, processing unit 23 generates session key K used in the session and a key ID which is an ID of session key K, and distributes generated session key K and key ID to the server and the client attending the session. Further, processing unit 23 stores generated session key K and key ID in storage unit 25 in association with the service ID.

For example, processing unit 23 encrypts session key K using the unique ID as the encryption key. Further, for example, processing unit 23 calculates a hash value HV using the unique ID and session key K. Then, processing unit 23 transmits encrypted session key K and a hash value HV to vehicle-mounted ECU 111 having the unique ID used for encrypting session key K and calculating hash value HV via relay unit 22.

More specifically, processing unit 23 refers to the connection destination list in storage unit 25, acquires the unique ID of the server indicated by the server information, and encrypts session key K using the acquired unique ID as the encryption key, thereby generating an encrypted key KS which is encrypted session key K for the server. Then, processing unit 23 includes encrypted key KS and the corresponding key ID in the Subscribe message included in the Ethernet frame in storage unit 25, and applies the Subscribe message and the unique ID of the server to a predetermined hash function to calculate a hash value HVS. Processing unit 23 further stores calculated hash value HVS in the Ethernet frame. Then, processing unit 23 outputs a relay instruction indicating that the relay processing of the Ethernet frame should be performed to relay unit 22.

When receiving the relay instruction from processing unit 23, relay unit 22 acquires the Ethernet frame indicated by the relay instruction from storage unit 25 and performs the relay processing of the Ethernet frame. Specifically, relay unit 22 transmits the Ethernet frame in which encrypted key KS, the key ID, and hash value HVS are stored to the server according to the destination MAC address of the Ethernet frame.

Further, processing unit 23 refers to the connection destination list in storage unit 25, acquires the unique ID of the client indicated by the client information, and encrypts session key K using the acquired unique ID as an encryption key, thereby generating an encrypted key KC which is encrypted session key K for the client. Then, processing unit 23 generates a start message MC including the endpoint information of the server, encrypted key KC, and the corresponding key ID, and calculates a hash value HVC by applying generated start message MC and the acquired unique ID to a predetermined hash function. Processing unit 23 generates an Ethernet frame addressed to the client and including generated start message MC and calculated hash value HVC, and transmits the generated Ethernet frame to the client via relay unit 22.

Processing unit 23 outputs, to log generation unit 24, session information indicating the service ID of the service provided in the session to be established, the ECU identifier of the server that is the destination of the Subscribe message, the ECU identifier of the client that is the destination of start message MC, and an output time ts of the Subscribe message and start message MC. Output time ts indicates the transmission time of session key K by relay unit 22.

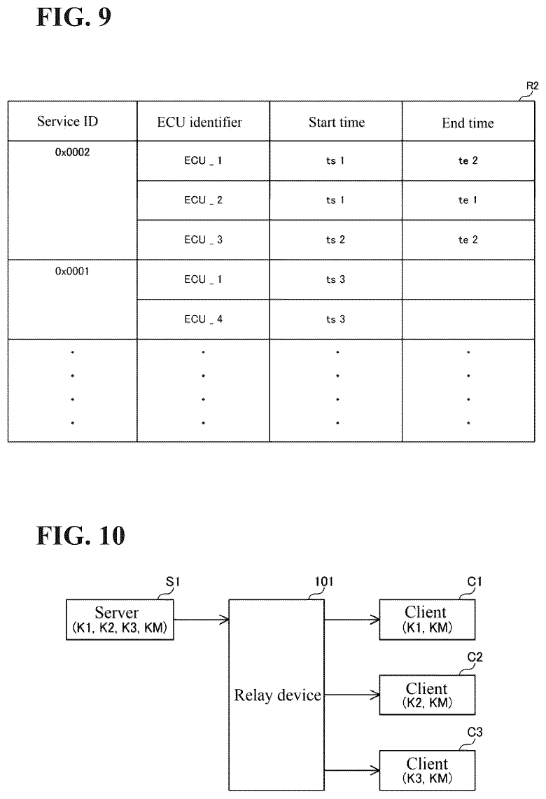

FIG. 9 is a diagram showing an example of a session log list in the storage unit in the relay device according to the first embodiment of the present disclosure. Referring to FIG. 9, storage unit 25 stores a session log list R2 which is a list of session logs indicating the service ID of the service provided in the session to be established, each ECU identifier of the server and the client to which session key K is distributed, the start time of the session, and the end time of the session.

Log generation unit 24 receives the session information from processing unit 23 and writes the service ID, the ECU identifier, and output time ts included in the received session information into session log list R2 as the “service ID”, the “ECU identifier”, and the “start time” of the session log, respectively.

### (1-6) Reception of Session Key by Server

Referring back to FIG. 5, in the server, processing unit 12 receives the Ethernet frame from relay device 101 via communication unit 11, and acquires the Subscribe message and hash value HVS from the received Ethernet frame. Processing unit 12 compares hash value HVS received from relay device 101 with the hash value calculated using session key K received from relay device 101 and its own unique ID.

More specifically, processing unit 12 acquires the unique ID from storage unit 13, and calculates the hash value by applying the Subscribe message and the unique ID to a predetermined hash function. Processing unit 12 compares hash value HVS with the hash value calculated by itself to determine whether the Subscribe message has been tampered with.

When processing unit 12 determines that the Subscribe message has been tampered with, processing unit 12 discards the Subscribe message. On the other hand, when processing unit 12 determines that the Subscribe message has not been tampered with, processing unit 12 acquires the endpoint information of the client, encrypted key KS, and the key ID from the Subscribe message. Then, processing unit 12 acquires session key K by decrypting encrypted key KS using the unique ID.

When the key ID of session key K acquired in the past is stored in storage unit 13, processing unit 12 compares the key ID in storage unit 13 with the newly acquired key ID. When processing unit 12 confirms that the key ID in storage unit 13 is different from the newly acquired key ID, processing unit 12 stores the newly acquired endpoint information of the client, session key K, and key ID in storage unit 13.

On the other hand, when the key ID in storage unit 13 matches the newly acquired key ID, processing unit 12 transmits a message requesting retransmission of session key K to relay device 101 via communication unit 11. When receiving the message, relay device 101 generates new session key K and transmits it to the server and the client. As a result, when same session key K as session key K used in the past session is distributed to the server and the client, it is possible to prompt relay device 101 to regenerate session key K, so that it is possible to avoid a decrease in security due to the use of same session key K in different sessions.

### (1-7) Reception of Session Key by Client

In the client, processing unit 12 receives the Ethernet frame from relay device 101 via communication unit 11 and acquires start message MC and hash value HVC from the received Ethernet frame. Processing unit 12 compares hash value HVC received from relay device 101 with the hash value calculated using session key K received from relay device 101 and its own unique ID.

More specifically, processing unit 12 acquires the unique ID from storage unit 13 and calculates the hash value by applying start message MC and the unique ID to a predetermined hash function. Processing unit 12 compares hash value HVC with the hash value calculated by itself to determine whether start message MC has been tampered with.

When processing unit 12 determines that start message MC has been tampered with, processing unit 12 discards start message MC. On the other hand, when processing unit 12 determines that start message MC has not been tampered with, processing unit 12 acquires the endpoint information of the server, encrypted key KC, and the key ID from start message MC. Then, processing unit 12 acquires session key K by decrypting encrypted key KC using the unique ID.

When the key ID of session key K acquired in the past is stored in storage unit 13, processing unit 12 compares the key ID in storage unit 13 with the newly acquired key ID. When processing unit 12 confirms that the key ID in storage unit 13 is different from the newly acquired key ID, processing unit 12 stores the newly acquired endpoint information of the server, session key K, and key ID in storage unit 13.

On the other hand, when the key ID in storage unit 13 matches the newly acquired key ID, processing unit 12 transmits a message requesting retransmission of session key K to relay device 101 via communication unit 11. When receiving the message, relay device 101 generates new session key K and transmits it to the server and the client.

Here, since the number of different session keys K that can be generated in relay device 101 is limited, there is a case where relay device 101 distributes same session key K as certain session key K with sufficient time after distributing certain session key K. Therefore, processing unit 12 in each of the server and the client deletes the key ID from storage unit 13 after a sufficient time has elapsed since the key ID was stored in storage unit 13.

### (2) Processing Example 2 in Service Discovery

### (2-1) Transmission of Find Message by Client

In vehicle-mounted ECU 111 serving as the client, processing unit 12 refers to the service list in storage unit 13 and acquires the service ID corresponding to the service to be provided. Further, processing unit 12 acquires the ECU identifier and the endpoint information of vehicle-mounted ECU 111 from storage unit 13. Processing unit 12 generates a Find message including the acquired service ID, ECU identifier, and endpoint information.

Processing unit 12 calculates a MAC value based on the generated Find message and the unique ID in storage unit 13. Processing unit 12 generates an Ethernet frame in which the Find message and the MAC value are stored in the data field and the multicasting address is stored as the destination MAC address. Processing unit 12 outputs the generated Ethernet frame to communication unit 11.

Communication unit 11 transmits the Ethernet frame received from processing unit 12 to relay device 101.

### (2-2) Determination of Propriety of Find Message by Relay Device

Referring back to FIG. 6, relay unit 22 in relay device 101 receives the Ethernet frame from the server via the corresponding communication port, adds a time stamp to the received Ethernet frame, and stores the Ethernet frame in storage unit 25.

When the Ethernet frame is stored in storage unit 25 by relay unit 22, processing unit 23 confirms that the SOME/IP-SD header is included in the data field of the Ethernet frame, and determines that the Ethernet frame includes the Find message by referring to the SOME/IP-SD header. Then, processing unit 23 determines whether the Ethernet frame is appropriate or inappropriate.

More specifically, processing unit 23 acquires the Find message, the MAC value, and the time stamp from the Ethernet frame. In addition, processing unit 23 acquires the service ID, the endpoint information of vehicle-mounted ECU 111, and the ECU identifier from the acquired Find message. Then, processing unit 23 refers to the connection destination list in storage unit 25 and confirms whether vehicle-mounted ECU 111 specified by the endpoint information and the ECU identifier acquired from the Find message is registered in the connection destination list as a client that can be involved in the service indicated by the service ID acquired from the Find message.

As an example, when the service ID, the endpoint information, and the ECU identifier acquired from the Find message are “0x0001”, “CCC”, and “ECU_3”, respectively, processing unit 23 determines that vehicle-mounted ECU 111 specified by the ECU identifier and the endpoint information is registered in the connection destination list as a client that can be involved in the service indicated by the service ID.

Further, processing unit 23 refers to the connection destination list and acquires the unique ID of vehicle-mounted ECU 111 specified by the endpoint information or the like acquired from the Find message. Processing unit 23 calculates a MAC value based on the Find message and the acquired unique ID. Then, processing unit 23 compares the MAC value acquired from the Ethernet frame with the MAC value calculated by itself to determine whether the Ethernet frame has been tampered with.

When processing unit 23 determines that vehicle-mounted ECU 111 specified by the endpoint information or the like acquired from the Find message is registered in the connection destination list and that the Ethernet frame has not been tampered with, processing unit 23 determines that the Ethernet frame received by relay unit 22 is appropriate. On the other hand, when vehicle-mounted ECU 111 specified by the endpoint information or the like acquired from the Find message is not registered in the connection destination list, or when processing unit 23 determines that the Ethernet frame has been tampered with, processing unit 23 determines that the Ethernet frame received by relay unit 22 is inappropriate.

When determining that the Ethernet frame is appropriate, processing unit 23 stores the ECU identifier and the endpoint information acquired from the Find message in storage unit 25 as the client information.

When determining that the Ethernet frame received by relay unit 22 is appropriate, processing unit 23 deletes the ECU identifier and the endpoint information from the Find message included in the Ethernet frame in storage unit 25. Then, processing unit 23 outputs a relay instruction indicating that the relay processing of the Ethernet frame should be performed to relay unit 22.

When receiving the relay instruction from processing unit 23, relay unit 22 acquires the Ethernet frame indicated by the relay instruction from storage unit 25 and performs the relay processing of the Ethernet frame.

On the other hand, when processing unit 23 determines that the Ethernet frame received by relay unit 22 is inappropriate, processing unit 23 outputs a discard-instruction indicating that the Ethernet frame should be discarded to relay unit 22.

When relay unit 22 receives the discard-instruction from processing unit 23, relay unit 22 discards the Ethernet frame indicated by the discard-instruction.

When processing unit 23 determines that the Ethernet frame received by relay unit 22 is inappropriate, processing unit 23 outputs the Find message and the time stamp to log generation unit 24.

Log generation unit 24 receives the Find message and the time stamp from processing unit 23, acquires the ECU identifier included in the received Find message, and writes the byte string of the Find message, the acquired ECU identifier, and the reception time as an invalid log into invalid log list R1 in storage unit 25.

### (2-3) Transmission of Offer Message by Server

Referring back to FIG. 5, in vehicle-mounted ECU 111 as the server, processing unit 12 receives the Ethernet frame from relay device 101 via communication unit 11, and acquires the source MAC address and the Find message from the received Ethernet frame. Further, processing unit 12 acquires the service ID from the acquired Find message.

Processing unit 12 refers to the service list in storage unit 13 and determines whether the service indicated by the acquired service ID can be provided. When determining that the service can be provided, processing unit 12 acquires the ECU identifier and the endpoint information of vehicle-mounted ECU 111 from storage unit 13 and generates an Offer message including the service ID corresponding to the service, the acquired ECU identifier, and the acquired endpoint information. On the other hand, when processing unit 12 determines that it is impossible to provide the service, processing unit 12 does not generate the Offer message.

Processing unit 12 calculates a MAC value based on the generated Offer message and the unique ID in storage unit 13. Processing unit 12 generates an Ethernet frame in which the Offer message and the MAC value are stored in the data field and the MAC address of the client serving as the source of the Find message is stored as the destination MAC address. Processing unit 12 outputs the generated Ethernet frame to communication unit 11.

Communication unit 11 transmits the Ethernet frame received from processing unit 12 to relay device 101.

### (2-4) Determination of Propriety of Offer Message by Relay Device

Referring back to FIG. 6, relay unit 22 in relay device 101 receives the Ethernet frame from the server via the corresponding communication port, adds a time stamp to the received Ethernet frame, and stores the Ethernet frame in storage unit 25.

Processing unit 23 determines whether the Ethernet frame received by relay unit 22 is appropriate or inappropriate in the same way as in “(1-2) Determination of Propriety of Offer Message by Relay Device” described above. When determining that the Ethernet frame is appropriate, processing unit 23 stores the server information in storage unit 25 and outputs a relay instruction to relay unit 22.

When receiving the relay instruction from processing unit 23, relay unit 22 acquires the Ethernet frame indicated by the relay instruction from storage unit 25 and performs the relay processing of the Ethernet frame.

### (2-5) Transmission of Subscribe Message by Client

Referring back to FIG. 5, in vehicle-mounted ECU 111 as the client, processing unit 12 generates an Ethernet frame in which the Subscribe message and the MAC value are stored in the data field and the MAC address of the server serving as the source of the Offer message is stored as the destination MAC address, and transmits the generated Ethernet frame to relay device 101 via communication unit 11 in the same way as in “(1-3) Transmission of Subscribe Message by Client” described above.

### (2-6) Determination of Propriety of Subscribe Message by Relay Device

Referring back to FIG. 6, relay unit 22 in relay device 101 receives the Ethernet frame from the client via the corresponding communication port, adds a time stamp to the received Ethernet frame, and stores the Ethernet frame in storage unit 25.

Processing unit 23 determines whether the Ethernet frame received by relay unit 22 is appropriate or inappropriate in the same way as in “(1-4) Determination of Propriety of Subscribe Message by Relay Device” described above. When determining that the Ethernet frame is appropriate, processing unit 23 stores the ECU identifier and the endpoint information acquired from the Subscribe message in storage unit 25 as the client information.

### (2-7) Generation and Distribution of Session Key by Relay Device

Processing unit 23 in relay device 101 determines to establish the session between the server and the client, generates session key K used in the session and a key ID that is an ID of session key K, and distributes generated session key K and key ID to the server and the client attending the session in the same way as in “(1-5) Generation and Distribution of Session Key by Relay Device” described above.

### (2-8) Reception of Session Key by Server and Client

Referring back to FIG. 5, in the server, processing unit 12 compares hash value HVS received from relay device 101 with the hash value calculated using session key K received from relay device 101 and its own unique ID in the same way as in “(1-6) Reception of Session Key by Server” described above.

Further, in the client, processing unit 12 compares hash value HVC received from relay device 101 with the hash value calculated using session key K received from relay device 101 and its own unique ID in the same way as in “(1-7) Reception of Session Key by Client” described above.

### (Communication in Session)

When the server and the client acquire session key K, the server and the client start the session of communication using session key K.

Specifically, in the server, processing unit 12 encrypts a session message storing information to be provided as a service using session key K in storage unit 13, includes the encrypted session message in an Ethernet frame, and transmits the Ethernet frame to the client via communication unit 11 and relay device 101.

In the client, processing unit 12 acquires the session message from the Ethernet frame received from the server via relay device 101 and communication unit 11, decrypts the acquired session message using session key K in storage unit 13, and acquires information from the decrypted session message.

### (Attendance at Existing Session)

For example, processing unit 12 in the server multicasts an Offer message regularly or irregularly even after the start of the session with a certain client.

More specifically, processing unit 23 in relay device 101 determines to establish the session between a server S1 and a client C2 when the Ethernet frame storing the Subscribe message from another client C2 is received by relay unit 22 after the session is established between server S1 and a client C1 and the Ethernet frame is determined to be appropriate. That is, processing unit 23 determines to establish the session between server S1 and client C2 after distributing a session key K1 to server S1 and client C1, for example.

In this case, for example, processing unit 23 generates a session key K2 different from session key K1 distributed to server S1 and client C1 as session key K used in the session between server S1 and client C2, and distributes generated session key K2 to server S1 and client C2.

That is, processing unit 23 generates and distributes different session key K for each combination of a server and a client.

(Multicasting from Server to Client)

In vehicle-mounted system 301, the server is not limited to the configuration of unicasting the session message to the client. The server may be configured to multicast a session message to a plurality of clients.

For example, processing unit 23 in relay device 101 generates, on a session-by-session basis, a session key K to be used in the session attended by, among the plurality of vehicle-mounted ECUs 111, vehicle-mounted ECU 111 serving as the source of the Ethernet frame determined to include the start-request such as the Offer message and a plurality of vehicle-mounted ECUs 111 serving as a source of the Ethernet frame determined to include the start-response such as the Subscribe message. More specifically, when the number of clients performing communication in the session with one server reaches a predetermined number, processing unit 23 generates a session key KM which is session key K used in the session between the server and the plurality of clients, and distributes generated session key KM to the server and the plurality of clients.

That is, for example, when processing unit 23 determines to establish the session between server S1 and a client C3 in a state where two sessions between server S1 and clients C1, C2 are established, processing unit 23 generates a session key K3 used in the session between server S1 and client C3 and distributes session key K3 to server S1 and client C3. Further, processing unit 23 further generates session key KM used in the session between server S1 and clients C1, C2, and C3 and a multicasting address based on the endpoint information of server S1 and clients C1, C2, and C3, and distributes generated session key KM and the multicasting address to server S1 and clients C1, C2, and C3.

When server S1 and clients C1, C2, and C3 acquire session key KM and the multicasting address, server S1 and clients C1, C2, and C3 start the session of communication using session key KM and the multicasting address.

FIG. 10 is a diagram showing an example of the session between a server and a client in the vehicle-mounted system according to the first embodiment of the present disclosure. Referring to FIG. 10, server S1 has session key K1 used in the session with client C1, session key K2 used in the session with client C2, session key K3 used in the session with client C3, and session key KM used in the session with clients C1, C2, and C3. Client C1 has session keys K1, KM. Client C2 has session keys K2, KM. Client C3 has session keys K3, KM.

In server S1, processing unit 12 encrypts a session message containing information to be provided as a service using session key KM, includes the encrypted session message in an Ethernet frame, and multicasts the Ethernet frame to clients C1, C2, and C3.

For example, server S1 is configured to, in response to detecting abnormality in vehicle-mounted system 301 in a state of transmitting information to clients C1, C2, and C3 by multicasting, change the state to a state of transmitting information to the plurality of clients C1, C2, and C3 by unicasting.

As an example, a case is considered in which an invalid device that has taken over client C1 pretends to be server S1 and multicasts a session message encrypted using session key KM to server S1 and clients C2 and C3 by including the session message in an Ethernet frame.

When processing unit 12 in server S1 receives the session message from the invalid device via communication unit 11, processing unit 12 determines that abnormality has occurred in vehicle-mounted system 301 because processing unit 12 itself has received the session message even though processing unit 12 itself is the source of the session message.

In this case, processing unit 12 in server S1 switches the transmission of the session message from multicasting to unicasting. Specifically, processing unit 12 unicasts the session message encrypted using session key K1 to client C1 via communication unit 11, unicasts the session message encrypted using session key K2 to client C2 via communication unit 11, and unicasts the session message encrypted using session key K3 to client C3 via communication unit 11.

### (3) Processing Example 3 in Service Discovery

### (3-1) Transmission of StopSubscribe Message by Client

Referring back to FIG. 5, in the client, when receiving the service is stopped, processing unit 12 generates a StopSubscribe message including the service ID, the ECU identifier, and the endpoint information corresponding to the service.

Processing unit 12 calculates a MAC value based on the generated StopSubscribe message and the unique ID in storage unit 13. Further, processing unit 12 encrypts the StopSubscribe message using session key K in storage unit 13. Then, processing unit 12 generates an Ethernet frame in which the encrypted StopSubscribe message and the MAC value are stored in the data field and the MAC address of the server is stored as the destination MAC address, and transmits the generated Ethernet frame to relay device 101 via communication unit 11.

Further, processing unit 12 discards session key K and the endpoint information of the server in storage unit 13.

### (3-2) Determination of Propriety of StopSubscribe Message by Relay Device

Referring back to FIG. 6, relay unit 22 in relay device 101 receives the Ethernet frame from the client via the corresponding communication port, adds a time stamp to the received Ethernet frame, and stores the Ethernet frame in storage unit 25.

When the Ethernet frame is stored in storage unit 25 by relay unit 22, processing unit 23 confirms that the SOME/IP-SD header is included in the data field of the Ethernet frame, and determines that the Ethernet frame includes the StopSubscribe message by referring to the SOME/IP-SD header. Then, processing unit 23 determines whether the Ethernet frame is appropriate or inappropriate.

More specifically, processing unit 23 acquires the StopSubscribe message, the MAC value, and the timestamp from the Ethernet frame. Further, processing unit 23 acquires the service ID, the endpoint information of vehicle-mounted ECU 111, and the ECU identifier from the acquired StopSubscribe message. Then, processing unit 23 refers to the connection destination list in storage unit 25 and confirms whether vehicle-mounted ECU 111 specified by the endpoint information and the ECU identifier acquired from the StopSubscribe message is registered in the connection destination list as a server that can be involved in the service indicated by the service ID acquired from the StopSubscribe message.

Further, processing unit 23 refers to the connection destination list and acquires the unique ID of vehicle-mounted ECU 111 specified by the endpoint information or the like acquired from the StopSubscribe message. Processing unit 23 calculates the MAC value based on the StopSubscribe message and the acquired unique ID. Then, processing unit 23 compares the MAC value acquired from the Ethernet frame with the MAC value calculated by itself to determine whether the Ethernet frame has been tampered with.

When processing unit 23 determines that vehicle-mounted ECU 111 specified by the endpoint information or the like acquired from the StopSubscribe message is registered in the connection destination list and that the Ethernet frame has not been tampered with, processing unit 23 determines that the Ethernet frame received by relay unit 22 is appropriate. On the other hand, when vehicle-mounted ECU 111 specified by the endpoint information or the like acquired from the StopSubscribe message is not registered in the connection destination list, or when processing unit 23 determines that the Ethernet frame has been tampered with, processing unit 23 determines that the Ethernet frame received by relay unit 22 is inappropriate.

When determining that the Ethernet frame is appropriate, processing unit 23 discards session key K and the key ID corresponding to the service ID included in the StopSubscribe message in storage unit 25.

When processing unit 23 determines that the Ethernet frame is appropriate, processing unit 23 notifies log generation unit 24 of a reception time to indicated by the time stamp acquired from the Ethernet frame.

Log generation unit 24 records the reception time of the StopSubscribe message by relay unit 22 as session information. More specifically, log generation unit 24 receives the notification of reception time te from processing unit 23 and writes notified reception time te into session log list R2 as the “end time” of the session log.

For example, relay unit 22 performs the relay processing on an Ethernet frame that is determined to include a StopSubscribe message by processing unit 23 and that is determined to be appropriate by processing unit 23.

More specifically, when determining that the Ethernet frame received by relay unit 22 is appropriate, processing unit 23 deletes the ECU identifier and the endpoint information from the StopSubscribe message included in the Ethernet frame in storage unit 25. Then, processing unit 23 outputs a relay instruction indicating that the relay processing of the Ethernet frame should be performed to relay unit 22.

When receiving the relay instruction from processing unit 23, relay unit 22 acquires the Ethernet frame indicated by the relay instruction from storage unit 25 and performs the relay processing of the Ethernet frame.

On the other hand, when processing unit 23 determines that the Ethernet frame received by relay unit 22 is inappropriate, processing unit 23 outputs a discard-instruction indicating that the Ethernet frame should be discarded to relay unit 22.

When relay unit 22 receives the discard-instruction from processing unit 23, relay unit 22 discards the Ethernet frame indicated by the discard-instruction.

When processing unit 23 determines that the Ethernet frame received by relay unit 22 is inappropriate, processing unit 23 outputs the StopSubscribe message and the time stamp to log generation unit 24.

Log generation unit 24 receives the StopSubscribe message and the time stamp, acquires the ECU identifier included in the received StopSubscribe message, and writes the byte string of the StopSubscribe message, the acquired ECU identifier, and the reception time as an invalid log into invalid log list R1 in storage unit 25.

### (3-3) Reception of StopSubscribe Message by Server

Referring back to FIG. 5, in the server, processing unit 12 receives the Ethernet frame from relay device 101 via communication unit 11, and acquires the StopSubscribe message from the received Ethernet frame. Processing unit 12 decrypts the acquired StopSubscribe message using session key K in storage unit 13. Processing unit 12 discards session key K and the endpoint information of the client in storage unit 13.

### (4) Processing Example 4 in Service Discovery

### (4-1) Transmission of StopOffer Message by Server

When the server stops providing the service, processing unit 12 generates a StopOffer message including the service ID, the ECU identifier, and the endpoint information corresponding to the service.

Processing unit 12 calculates a MAC value based on the generated StopOffer message and the unique ID in storage unit 13. Further, processing unit 12 encrypts the StopOffer message using session key K in storage unit 13. Then, processing unit 12 generates an Ethernet frame in which the encrypted StopOffer message and the MAC value are stored in the data field and the MAC address of the client is stored as the destination MAC address, and transmits the generated Ethernet frame to relay device 101 via communication unit 11.

Further, processing unit 12 discards session key K and the endpoint information of the client in storage unit 13.

### (4-2) Determination of Propriety of StopOffer Message by Relay Device

Referring back to FIG. 6, relay unit 22 in relay device 101 receives the Ethernet frame from the server via the corresponding communication port, adds a time stamp to the received Ethernet frame, and stores the Ethernet frame in storage unit 25.

When the Ethernet frame is stored in storage unit 25 by relay unit 22, processing unit 23 confirms that the SOME/IP-SD header is included in the data field of the Ethernet frame, and determines that the Ethernet frame includes the StopOffer message by referring to the SOME/IP-SD header. Then, processing unit 23 determines whether the Ethernet frame is appropriate or inappropriate.

More specifically, processing unit 23 acquires the StopOffer message, the MAC value, and the time stamp from the Ethernet frame. Further, processing unit 23 acquires the service ID, the endpoint information of vehicle-mounted ECU 111, and the ECU identifier from the acquired StopOffer message. Then, processing unit 23 refers to the connection destination list in storage unit 25 and confirms whether vehicle-mounted ECU 111 specified by the endpoint information and the ECU identifier acquired from the StopOffer message is registered in the connection destination list as a client that can be involved in the service indicated by the service ID acquired from the StopOffer message.

Further, processing unit 23 refers to the connection destination list and acquires the unique ID of vehicle-mounted ECU 111 specified by the endpoint information or the like acquired from the StopOffer message. Processing unit 23 calculates the MAC value based on the StopOffer message and the acquired unique ID. Then, processing unit 23 compares the MAC value acquired from the Ethernet frame with the MAC value calculated by itself to determine whether the Ethernet frame has been tampered with.

When processing unit 23 determines that vehicle-mounted ECU 111 specified by the endpoint information or the like acquired from the StopOffer message is registered in the connection destination list and that the Ethernet frame has not been tampered with, processing unit 23 determines that the Ethernet frame received by relay unit 22 is appropriate. On the other hand, when vehicle-mounted ECU 111 specified by the endpoint information or the like acquired from the StopOffer message is not registered in the connection destination list, or when processing unit 23 determines that the Ethernet frame has been tampered with, processing unit 23 determines that the Ethernet frame received by relay unit 22 is inappropriate.

When determining that the Ethernet frame is appropriate, processing unit 23 discards session key K and the key ID corresponding to the service ID included in the StopOffer message in storage unit 25.

When processing unit 23 determines that the Ethernet frame is appropriate, processing unit 23 notifies log generation unit 24 of reception time te indicated by the time stamp acquired from the Ethernet frame.

Log generation unit 24 records the reception time of the StopOffer message by relay unit 22 as session information. More specifically, log generation unit 24 receives the notification of reception time te from processing unit 23 and writes notified reception time te into session log list R2 as the “end time” of the session log.

For example, relay unit 22 performs the relay processing on an Ethernet frame that is determined to include a StopOffer message by processing unit 23 and that is determined to be appropriate by processing unit 23.

More specifically, when determining that the Ethernet frame received by relay unit 22 is appropriate, processing unit 23 deletes the ECU identifier and the endpoint information from the StopOffer message included in the Ethernet frame in storage unit 25. Then, processing unit 23 outputs a relay instruction indicating that the relay processing of the Ethernet frame should be performed to relay unit 22.

When receiving the relay instruction from processing unit 23, relay unit 22 acquires the Ethernet frame indicated by the relay instruction from storage unit 25 and performs the relay processing of the Ethernet frame.

On the other hand, when processing unit 23 determines that the Ethernet frame received by relay unit 22 is inappropriate, processing unit 23 outputs a discard-instruction indicating that the Ethernet frame should be discarded to relay unit 22.

When relay unit 22 receives the discard-instruction from processing unit 23, relay unit 22 discards the Ethernet frame indicated by the discard-instruction.

When processing unit 23 determines that the Ethernet frame received by relay unit 22 is inappropriate, processing unit 23 outputs the StopOffer message and the time stamp to log generation unit 24.

Log generation unit 24 receives the StopOffer message and the time stamp, acquires the ECU identifier included in the received StopOffer message, and writes the byte string of the StopOffer message, the acquired ECU identifier, and the reception time as an invalid log into invalid log list R1 in storage unit 25.

### (4-3) Reception of StopOffer Message by Client

Referring back to FIG. 5, in the client, processing unit 12 receives the Ethernet frame from relay device 101 via communication unit 11, and acquires the StopOffer message from the received Ethernet frame. Processing unit 12 decrypts the acquired StopOffer message using session key K in storage unit 13. Processing unit 12 discards session key K and the endpoint information of the server in storage unit 13.

### [Operation Flow]

Each device in the vehicle-mounted system according to the embodiment of the present disclosure includes a computer including a memory, and a calculation processing unit such as a CPU in the computer reads a program including some or all of steps of the following flowcharts and sequences from the memory and executes the program. The programs of the plurality of devices can be respectively installed from the outside. The programs of the plurality of devices are respectively distributed in a state of being stored in a recording medium or via a communication line.

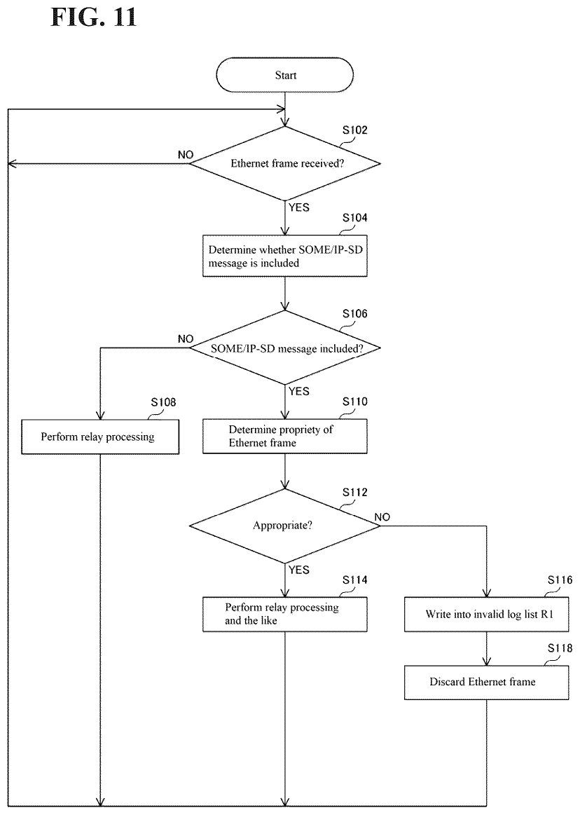

FIG. 11 is a flowchart defining an example of an operation procedure when the relay device distributes a session key according to the first embodiment of the present disclosure.

Referring to FIG. 11, first, relay device 101 waits for an Ethernet frame from vehicle-mounted ECU 111 (NO in step S102), and upon receiving the Ethernet frame (YES in step S102), determines that the received Ethernet frame includes a SOME/IP-SD message. For example, relay device 101 determines whether the received Ethernet frame includes a SOME/IP-SD message (step S104).

Next, when determining that the received Ethernet frame does not include the SOME/IP-SD message (NO in step S106), relay device 101 performs the relay processing of the Ethernet frame (step S108).

Next, relay device 101 waits for a new Ethernet frame from vehicle-mounted ECU 111 (NO in step S102).

On the other hand, when determining that the received Ethernet frame includes the SOME/IP-SD message (YES in step S106), relay device 101 determines whether the Ethernet frame is appropriate or inappropriate (step S110).

Next, when determining that the received Ethernet frame is appropriate (YES in step S112), relay device 101 performs the relay processing and the like on the Ethernet frame (step S114). Details of step S114 will be described later.

Next, relay device 101 waits for a new Ethernet frame from vehicle-mounted ECU 111 (NO in step S102).

On the other hand, when determining that the received Ethernet frame is inappropriate (NO in step S112), relay device 101 writes the byte string of the message included in the Ethernet frame, the ECU identifier included in the message, and the reception time of the Ethernet frame into invalid log list R1 as an invalid log (step S116).

Next, relay device 101 discards the received Ethernet frame (step S118), and waits for a new Ethernet frame from vehicle-mounted ECU 111 (NO in step S102).

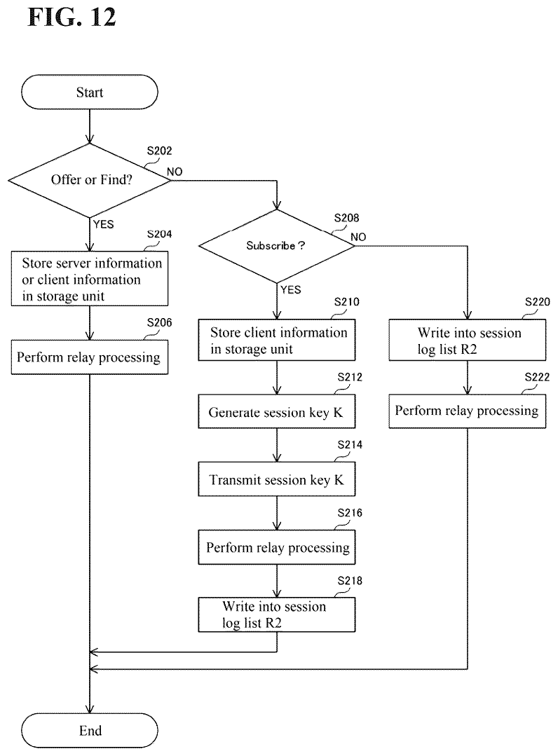

FIG. 12 is a flowchart defining an example of an operation procedure when the relay device distributes a session key according to the first embodiment of the present disclosure. FIG. 12 shows the details of step S114 in FIG. 11.

Referring to FIG. 12, when determining that the received Ethernet frame includes an Offer message or a Find message (YES in step S202), relay device 101 stores server information or client information in storage unit 25. More specifically, when determining that the received Ethernet frame includes Offer message, relay device 101 stores the ECU identifier and the endpoint information acquired from the Offer message in storage unit 25 as the server information. On the other hand, when determining that the received Ethernet frame includes the Find message, relay device 101 stores the ECU identifier and the endpoint information acquired from the Find message in storage unit 25 as client information (step S204).

Next, relay device 101 performs the relay processing of the received Ethernet frame (step S206).

On the other hand, when determining that the received Ethernet frame includes the Subscribe message (NO in step S202 and YES in step S208), relay device 101 stores the ECU identifier and the endpoint information acquired from the Subscribe message in storage unit 25 as the client information (step S210).

Next, relay device 101 determines to establish the session between the server and the client, and generates session key K to be used in the session (step S212).

Next, relay device 101 transmits generated session key K to the client attending the session. More specifically, relay device 101 generates start message MC including encrypted key KC and transmits an Ethernet frame including generated start message MC to the client (step S214).

Next, relay device 101 performs the relay processing of the received Ethernet frame. More specifically, relay device 101 includes encrypted key KS in the Subscribe message included in the received Ethernet frame and transmits the Ethernet frame to the server (step S216).

Next, relay device 101 writes the service ID of the service provided in the session to be established, each ECU identifier of the server and the client that are the destinations of session key K, and the start time of the session into session log list R2 as the “service ID”, the “ECU identifier”, and the “start time” of the session log (step S218).

On the other hand, when determining that the received Ethernet frame includes a StopSubscribe message or a StopOffer message (NO in step S202 and NO in step S208), relay device 101 writes reception time to of the Ethernet frame into session log list R2 as the “end time” of the session log (step S220).

Next, relay device 101 performs the relay processing of the received Ethernet frame (step S222).

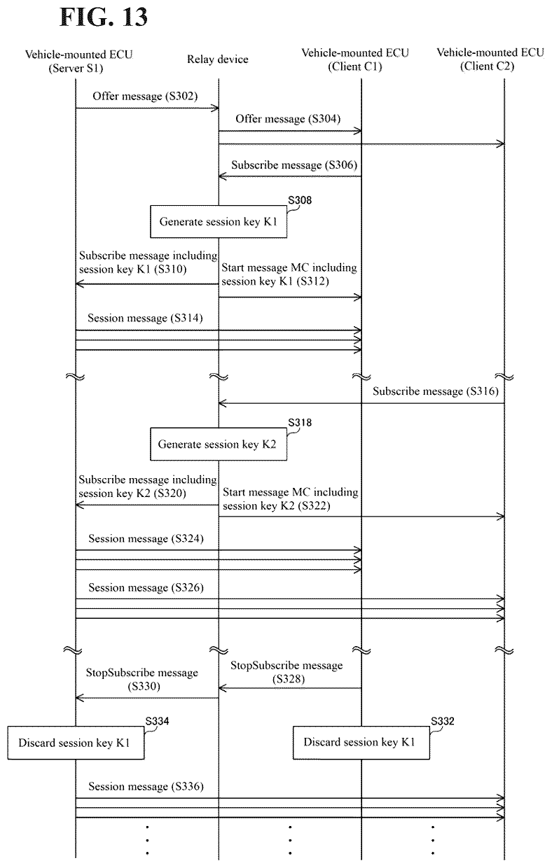

FIG. 13 is a diagram showing an example of a sequence of communication in the vehicle-mounted system according to the first embodiment of the present disclosure. FIG. 13 shows a communication sequence in vehicle-mounted system 301 including server S1 and clients C1 and C2.

Referring to FIG. 13, first, server S1 transmits an Ethernet frame in which an Offer message is stored in a data field and a multicasting address is stored as a destination MAC address to relay device 101 (step S302).

Next, relay device 101 determines that the Ethernet frame received from server S1 includes an Offer message, and determines whether the Ethernet frame is appropriate or inappropriate. Then, relay device 101 determines that the Ethernet frame is appropriate, and performs the relay processing on the Ethernet frame (step S304).

Next, for example, client C1 acquires the Offer message from the Ethernet frame received from server S1 via relay device 101, and determines that the service provided by server S1 is necessary. Then, client C1 transmits the Ethernet frame in which the Subscribe message is stored in the data field and the MAC address of server S1 is stored as the destination MAC address to relay device 101 (step S306).

Next, relay device 101 determines that the Ethernet frame received from client C1 includes the Subscribe message, and determines whether the Ethernet frame is appropriate or inappropriate. Then, relay device 101 determines that the Ethernet frame is appropriate, determines to establish the session between server S1 and client C1, and generates session key K1 to be used in the session. At this time, relay device 101 writes the service ID of the service provided in the session to be established, each ECU identifier of server S1 and client C1, and the start time of the session into session log list R2 as the “service ID”, the “ECU identifier”, and the “start time” of the session log, respectively (step S308).

Next, relay device 101 includes session key K1 in the Subscribe message included in the Ethernet frame received from client C1 and transmits the Ethernet frame to server S1 (step S310).

In addition, relay device 101 generates start message MC including session key K1 and transmits an Ethernet frame including generated start message MC to client C1 (step S312).

Next, for example, periodically, server S1 generates an Ethernet frame in which a session message encrypted using session key K1 is stored, and transmits the generated Ethernet frame to client C1 via relay device 101 (step S314).

Next, for example, client C2 acquires the Offer message from the Ethernet frame received from server S1 via relay device 101, and determines that the service provided by server S1 is necessary. Then, client C2 transmits the Ethernet frame in which the Subscribe message is stored in the data field and the MAC address of server S1 is stored as the destination MAC address to relay device 101 (step S316).

Next, relay device 101 determines that the Ethernet frame received from client C2 includes the Subscribe message, and determines whether the Ethernet frame is appropriate or inappropriate. Then, relay device 101 determines that the Ethernet frame is appropriate, determines to establish the session between server S1 and client C2, and generates session key K2 to be used in the session. At this time, relay device 101 writes the service ID of the service provided in the session to be established, each ECU identifier of server S1 and client C2, and the start time of the session into session log list R2 as the “service ID”, the “ECU identifier”, and the “start time” of the session log, respectively (step S318).

Next, relay device 101 includes session key K2 in the Subscribe message included in the Ethernet frame received from client C2 and transmits the Ethernet frame to server S1 (step S320).

In addition, relay device 101 generates start message MC including session key K2 and transmits an Ethernet frame including generated start message MC to client C2 (step S322).

Next, for example, periodically, server S1 generates an Ethernet frame in which a session message encrypted using session key K1 is stored, and transmits the generated Ethernet frame to client C1 via relay device 101 (step S324).

In addition, server S1, for example, periodically generates an Ethernet frame in which a session message encrypted using session key K2 is stored, and transmits the generated Ethernet frame to client C2 via relay device 101 (step S326).

Next, for example, client C1 transmits the Ethernet frame in which the StopSubscribe message is stored in the data field and the MAC address of server S1 is stored as the destination MAC address to relay device 101 (step S328).

Next, relay device 101 determines that the Ethernet frame received from client C1 includes a StopSubscribe message, and determines whether the Ethernet frame is appropriate or inappropriate. Then, relay device 101 determines that the Ethernet frame is appropriate, and performs the relay processing on the Ethernet frame. At this time, relay device 101 writes reception time to of the Ethernet frame into session log list R2 as the “end time” of the session log (step S330).

Next, client C1 discards session key K1 and the endpoint information of server S1 in storage unit 13 (step S332).

Further, server S1 discards session key K1 and the endpoint information of client C1 in storage unit 13 (step S334).

Next, server S1 continues to transmit the Ethernet frame in which the session message is stored to client C2 (step S336).

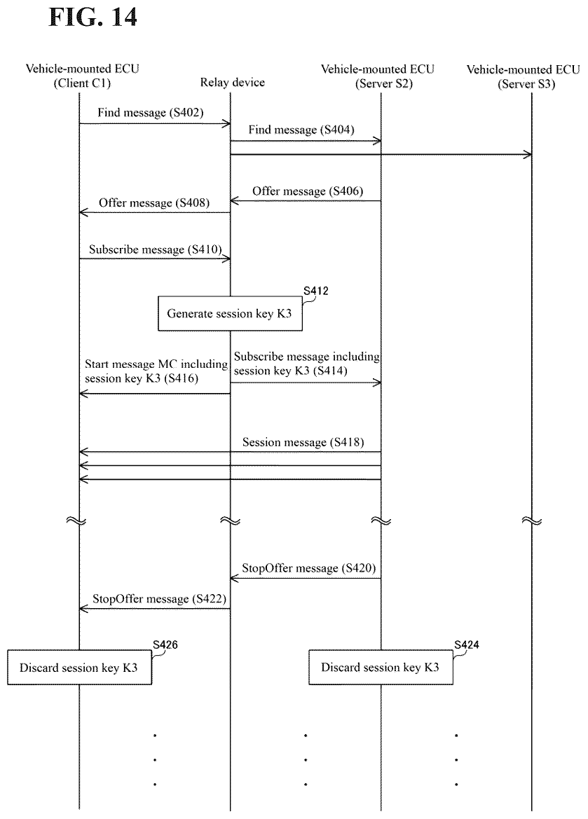

FIG. 14 is a diagram showing another example of a sequence of communication in the vehicle-mounted system according to the first embodiment of the present disclosure. FIG. 14 shows a communication sequence in vehicle-mounted system 301 including servers S2 and S3 and client C1.

Referring to FIG. 14, first, client C1 transmits the Ethernet frame in which the Find message is stored in the data field and the multicasting address is stored as the destination MAC address to relay device 101 (step S402).

Next, relay device 101 determines that the Ethernet frame received from client C1 includes the Find message, and determines whether the Ethernet frame is appropriate or inappropriate. Then, relay device 101 determines that the Ethernet frame is appropriate, and performs the relay processing on the Ethernet frame (step S404).

Next, for example, a server S2 transmits the Ethernet frame in which the Offer message is stored in the data field and the MAC address of client C1 is stored as the destination MAC address to relay device 101 (step S406).

Next, relay device 101 determines that the Ethernet frame received from server S2 includes an Offer message, and determines whether the Ethernet frame is appropriate or inappropriate. Then, relay device 101 determines that the Ethernet frame is appropriate, and performs the relay processing on the Ethernet frame (step S408).

Next, client C1 transmits the Ethernet frame in which the Subscribe message is stored in the data field and the MAC address of server S2 is stored as the destination MAC address to relay device 101 (step S410).

Next, relay device 101 determines that the Ethernet frame received from client C1 includes the Subscribe message, and determines whether the Ethernet frame is appropriate or inappropriate. Then, relay device 101 determines that the Ethernet frame is appropriate, determines to establish the session between server S2 and client C1, and generates session key K3 to be used in the session. At this time, relay device 101 writes the service ID of the service provided in the session to be established, each ECU identifier of server S3 and client C1, and the start time of the session into session log list R2 as the “service ID”, the “ECU identifier”, and the “start time” of the session log, respectively (step S412).

Next, relay device 101 includes session key K3 in the Subscribe message included in the Ethernet frame received from client C1 and transmits the Ethernet frame to server S2 (step S414).

In addition, relay device 101 generates start message MC including session key K3 and transmits an Ethernet frame including generated start message MC to client C1 (step S416).

Next, for example, periodically, server S2 generates an Ethernet frame in which a session message encrypted using session key K3 is stored, and transmits the generated Ethernet frame to client C1 via relay device 101 (step S418).

Next, for example, server S2 transmits the Ethernet frame in which the StopOffer message is stored and the MAC address of client C1 is stored as the destination MAC address to relay device 101 (step S420).

Next, relay device 101 determines that the Ethernet frame received from server S2 includes the StopOffer message and determines whether the Ethernet frame is appropriate or inappropriate. Then, relay device 101 determines that the Ethernet frame is appropriate, and performs the relay processing on the Ethernet frame. At this time, relay device 101 writes reception time to of the Ethernet frame into session log list R2 as the “end time” of the session log (step S422).

Next, server S2 discards session key K3 and the endpoint information of client C1 in storage unit 13 (step S424).

Further, client C1 discards session key K3 and the endpoint information of server S1 in storage unit 13 (step S426).

In vehicle-mounted system 301 according to the first embodiment of the present disclosure, the server is configured to, in response to detecting abnormality in vehicle-mounted system 301 in a state of transmitting information to the plurality of clients by multicasting, change the state to a state of transmitting information to the plurality of clients by unicasting, but the present disclosure is not limited thereto. The server may be configured not to change the state to a state of transmitting information to the plurality of clients by unicasting. Further, the server may be configured to transmit information to the plurality of clients by unicasting but not to transmit information by multicasting.

In vehicle-mounted system 301 according to the first embodiment of the present disclosure, relay device 101 and vehicle-mounted ECU 111 are connected to each other not via another relay device, but the present disclosure is not limited to thereto. Relay device 101 and vehicle-mounted ECU 111 may be connected to each other via another relay device. In this case, for example, the another relay device relays all the Ethernet frames received from vehicle-mounted ECU 111 connected to the another relay device to relay device 101.

In relay device 101 according to the first embodiment of the present disclosure, processing unit 23 is configured to transmit session key K, which has been encrypted using the unique ID as the encryption key, via relay unit 22 to vehicle-mounted ECU 111 having the unique ID, but the present disclosure is not limited thereto. Processing unit 23 may be configured to transmit unencrypted session key K to vehicle-mounted ECU 111 via relay unit 22.

In relay device 101 according to the first embodiment of the present disclosure, processing unit 23 is configured to transmits hash value HV, which is calculated using the unique ID and session key K, via relay unit 22 to vehicle-mounted ECU 111 having the unique ID, but the present disclosure is not limited thereto. Processing unit 23 may be configured not to transmit hash value HV to vehicle-mounted ECU 111.

Although relay device 101 according to the first embodiment of the present disclosure includes log generation unit 24, the present disclosure is not limited thereto. Relay device 101 may not include log generation unit 24.

In addition, in relay device 101 according to the first embodiment of the present disclosure, log generation unit 24 is configured to write the start time and the end time of the session into session log list R2, but the present disclosure is not limited thereto. Log generation unit 24 may be configured to write the service ID of the service provided in the session, the ECU identifier of the server attending the session, and the ECU identifier of the client attending the session into session log list R2, but not to write at least one of the start time and the end time of the session into session log list R2.

In relay device 101 according to the first embodiment of the present disclosure, when processing unit 23 is configured to determine that the Ethernet frame received by relay unit 22 includes the SOME/IP-SD message, processing unit 23 determines whether the Ethernet frame is appropriate or inappropriate, but the present disclosure is not limited thereto. Processing unit 23 may be configured not to determine whether the Ethernet frame including the SOME/IP-SD message is appropriate or inappropriate.

In addition, in relay device 101 according to the first embodiment of the present disclosure, processing unit 23 is configured to generate session key K having random contents on a session-by-session basis, but the present disclosure is not limited thereto. Processing unit 23 may be configured to generate session key K having a regular content on a session-by-session basis.

Meanwhile, there is a demand for a technology capable of further improving security in a vehicle-mounted network. More specifically, for example, in a vehicle-mounted system that performs service-oriented communication, a technique capable of further improving security in the vehicle-mounted network is desired.

On the other hand, in relay device 101 according to the first embodiment of the present disclosure, relay unit 22 performs the relay processing for transmitting the plurality of Ethernet frames received respectively from the plurality of vehicle-mounted ECU 111 to vehicle-mounted ECU 111 serving as destinations. Processing unit 23 determines that the multiple Ethernet frames received by relay unit 22 include a start-request and a start-response. Processing unit 23 generates, on a session-by-session basis, session key K to be used in the session attended by, among the plurality of vehicle-mounted ECUs 111, vehicle-mounted ECU 111 serving as the source of the Ethernet frame determined to include the start-request and one or more vehicle-mounted ECUs 111 serving as a source of the Ethernet frame determined to include the start-response. Processing unit 23 transmits generated session key K to each vehicle-mounted ECU 111 attending the session via relay unit 22.

As described above, relay device 101 determines that the received frame includes a start-request and that the received frame includes a start-response. Relay device 101 generates, on a session-by-session basis, session key K to be used in the session attended by, among the plurality of vehicle-mounted devices, vehicle-mounted ECU 111 serving as a source of the frame including the start-request and one or more vehicle-mounted ECUs 111 serving as a source of the frame including the start-response. Relay device 101 transmits session key K to each vehicle-mounted ECU 111. With this configuration, it is possible to perform communication between vehicle-mounted ECU 111 using the individual session key K on a session-by-session basis, thereby improving the security of communication between vehicle-mounted ECU 111. In addition, for example, by generating and transmitting the common key after performing authentication of vehicle-mounted ECU 111 serving as the source of the start-request and vehicle-mounted ECU 111 serving as the source of the start-response, it is possible to prevent an invalid device from attending the session. Therefore, it is possible to further improve security in the vehicle-mounted network.

In relay device 101, when the number of clients performing communication in the session with one server reaches a predetermined number, processing unit 23 generates session key KM to be used in the session between the server and the plurality of clients, and distributes generated session key KM to the server and the plurality of clients. This configuration enables multicasting communication using session key KM for the server and the plurality of clients. Therefore, it is possible to improve security in a vehicle-mounted network in which messages are transmitted and received in accordance with SOME/IP.

In addition, according to the configuration in which relay device 101 generates session key K, relay device 101 can generate session key K while exchanging the start-request and the start-response between vehicle-mounted ECU 111 according to the existing specifications, as compared with the configuration in which a management device other than relay device 101 receives the start-request and the start-response to generate session key K. In addition, compared to a configuration in which a management device other than relay device 101 receives the start-request and the start-response and generates session key K, the hardware configuration can be simplified, and communication traffic in the vehicle-mounted network can be reduced because there is no need to transfer the frame including the start-request and the frame including the start-response from the relay device to the management device.

Next, other embodiments of the present disclosure will be described with reference to the drawings. Note that the same or corresponding parts in the drawings are denoted by the same reference numerals, and description thereof will not be repeated.

### Second Embodiment

Compared with vehicle-mounted system 301 according to the first embodiment, the present embodiment relates to a vehicle-mounted system 302 in which a management device 201, which is a device different from relay device 101, generates session key K. The vehicle-mounted system is the same as vehicle-mounted system 301 according to the first embodiment except for the contents described below.

### <Vehicle-Mounted System>

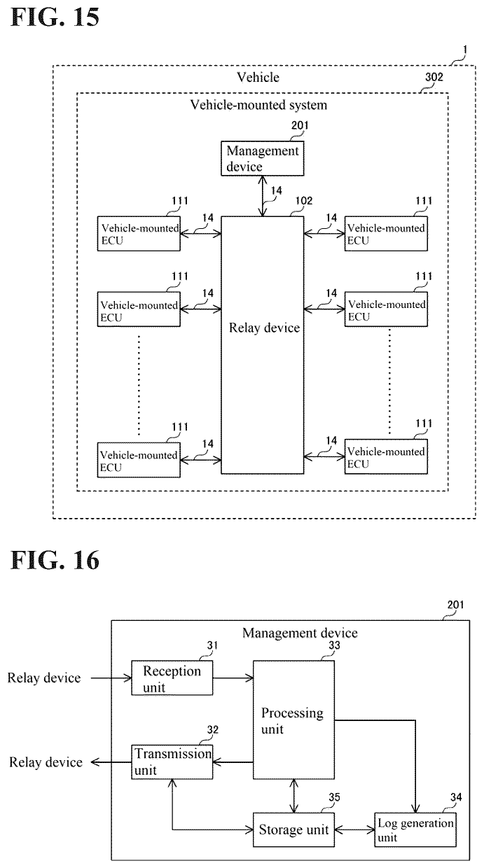

FIG. 15 is a diagram showing a configuration of a vehicle-mounted system according to a second embodiment of the present disclosure. Referring to FIG. 15, compared with vehicle-mounted system 301, vehicle-mounted system 302 includes a relay device 102 instead of relay device 101, and further includes management device 201. Vehicle-mounted ECU 111 and relay device 102 are examples of a vehicle-mounted device. Vehicle-mounted system 302 is mounted on vehicle 1. Management device 201 is used in vehicle-mounted system 302.

Relay device 102 is connected to management device 201 and each vehicle-mounted ECU 111 via cable 14. Management device 201, vehicle-mounted ECU 111, and relay device 102 constitute a vehicle-mounted network.

Relay device 102 is, for example, a central gateway (CGW), and can perform communication with management device 201 and vehicle-mounted ECU 111. Relay device 102 performs the relay processing for relaying information exchanged between a plurality of vehicle-mounted ECUs 111 connected to different cables 14 and information exchanged between vehicle-mounted ECU 111 and management device 201, for example. Hereinafter, it is assumed that communication between vehicle-mounted ECU 111 and communication between management device 201 and vehicle-mounted ECU 111 are performed via relay device 102 unless otherwise specified.

### (Offer Message)

For example, as a server, a certain vehicle-mounted ECU 111 regularly or irregularly transmits an Offer message including a service ID corresponding to a service that vehicle-mounted ECU 111 can provide to management device 201. The Offer message is an example of a start-request of the session.

Management device 201 receives the Offer message from the server and determines whether the received Offer message is appropriate or inappropriate. When management device 201 determines that the received Offer message is inappropriate, it discards the Offer message. On the other hand, when determining that the received Offer message is appropriate, management device 201 multicasts the Offer message to the plurality of vehicle-mounted ECUs 111.

Among the plurality of vehicle-mounted ECUs 111 that have received the Offer message from management device 201, vehicle-mounted ECU 111 that requires the service corresponding to the service ID included in the Offer message transmits, as a client, a Subscribe message indicating that the service is requested to management device 201. The Subscribe message is an example of a start-response to a start-request of the session.

When receiving the Subscribe message from the client, management device 201 determines to establish the session between the server and the client. Then, management device 201 generates session key K used in the session and unique to the session. That is, management device 201 generates session key K used in the session on a session-by-session basis. Session key K is an example of a common key, and is, for example, a random number having a key length according to an encryption scheme to be used. For example, management device 201 generates session key K having random contents on a session-by-session basis. Management device 201 transmits generated session key K to the server and the client attending the session.

### (Find Message)

For example, a certain vehicle-mounted ECU 111, as a client, regularly or irregularly transmits a Find message including a service ID corresponding to a service to be provided to management device 201. The Find message is an example of a search-request for the session.

Management device 201 receives the Find message from the client and determines whether the received Find message is appropriate or inappropriate. When management device 201 determines that the received Find message is inappropriate, it discards the Find message. On the other hand, when determining that the received Find message is appropriate, management device 201 multicasts the Find message to the plurality of vehicle-mounted ECUs 111.

Among the plurality of vehicle-mounted ECUs 111 that receive the Find message from management device 201, vehicle-mounted ECU 111 that can provide the service corresponding to the service ID included in the Find message serves as a server and transmits an Offer message indicating that the service can be provided to management device 201. The Offer message is an example of a start-request in response to a search-request for the session.

Management device 201 receives the Offer message from the server and determines whether the received Offer message is appropriate or inappropriate. When management device 201 determines that the received Offer message is inappropriate, it discards the Offer message. On the other hand, when management device 201 determines that the received Offer message is appropriate, it transmits the Offer message to the client.

The client having received the Offer message from management device 201 transmits a Subscribe message to management device 201. The Subscribe message is an example of a start-response to a start-request of the session.

When receiving the Subscribe message from the client, management device 201 determines to establish the session between the server and the client. Then, management device 201 generates session key K used in the session and unique to the session. Management device 201 transmits generated session key K to the server and the client attending the session.

### <Processing in Vehicle-Mounted ECU and Management Device>

FIG. 16 is a diagram showing a configuration of a management device according to the second embodiment of the present disclosure. Referring to FIG. 16, management device 201 includes a reception unit 31, a transmission unit 32, a processing unit 33, a log generation unit 34, and a storage unit 35. Processing unit 33 is an example of a generation unit. Log generation unit 34 is an example of a recording unit. Reception unit 31, transmission unit 32, processing unit 33, and log generation unit 34 are realized by processors such as a CPU and a DSP, for example. Storage unit 35 is, for example, a nonvolatile memory.

Reception unit 31 receives a start-request of the session and a start-response to the start-request from each of the plurality of vehicle-mounted ECUs 111. Processing unit 33 generates session key K that is used in the session associated with the start-request and the start-response received by reception unit 31 and is unique to the session. That is, processing unit 33 generates session key K to be used in the session in which vehicle-mounted ECU 111 serving as the source of the start-request received by reception unit 31 and vehicle-mounted ECU 111 serving as the source of the start-response received by reception unit 31 attend. For example, processing unit 33 generates session key K having random contents on a session-by-session basis. Transmission unit 32 transmits session key K generated by processing unit 33 to each vehicle-mounted ECU 111 attending the session. Log generation unit 34 records session information about the session in which session key K generated by processing unit 33 is used.

Storage unit 35 stores the unique ID of each vehicle-mounted ECU 111 in vehicle-mounted system 302. For example, storage unit 35 stores the connection destination list shown in FIG. 7.

### (1) Processing Example 1 in Service Discovery

### (1-1) Transmission of Offer Message by Server

Referring back to FIG. 5, in vehicle-mounted ECU 111 as the server, processing unit 12 refers to the service list in storage unit 13 and acquires the service ID corresponding to the service that vehicle-mounted ECU 111 can provide. Further, processing unit 12 acquires the ECU identifier and the endpoint information of its own vehicle-mounted ECU 111 from storage unit 13. Processing unit 12 generates an Offer message including the acquired service ID, ECU identifier, and endpoint information.

Processing unit 12 calculates a MAC value based on the generated Offer message and the unique ID in storage unit 13. Processing unit 12 outputs the generated Offer message and the calculated MAC value to communication unit 11.

Communication unit 11 receives the Offer message and the MAC value from processing unit 12, and transmits the received Offer message and MAC value to management device 201.

### (1-2) Determination of Propriety of Offer Message by Management Device

Referring back to FIG. 16, reception unit 31 in management device 201 receives the Offer message and the MAC value from the server. Reception unit 31 attaches a time stamp to the received Offer message and outputs the Offer message and the MAC value to processing unit 33.

Processing unit 33 receives the Offer message and the MAC value from reception unit 31 and determines whether the received Offer message is appropriate or inappropriate.

More specifically, processing unit 33 acquires the service ID, the endpoint information of vehicle-mounted ECU 111, and the ECU identifier from the Offer message. Then, processing unit 33 refers to the connection destination list in storage unit 35 and confirms whether vehicle-mounted ECU 111 specified by the endpoint information and the ECU identifier acquired from the Offer message is registered in the connection destination list as a server that can be involved in the service indicated by the service ID acquired from the Offer message.

As an example, when the service ID, the endpoint information, and the ECU identifier acquired from the Offer message are “0x0001”, “BBB”, and “ECU_2”, respectively, processing unit 33 determines that vehicle-mounted ECU 111 specified by the ECU identifier and the endpoint information is registered in the connection destination list as a server that can be involved in the service indicated by the service ID.

Further, processing unit 33 refers to the connection destination list and acquires the unique ID of vehicle-mounted ECU 111 specified by the endpoint information or the like acquired from the Offer message. Processing unit 33 calculates a MAC value based on the Offer message and the acquired unique ID. Then, processing unit 33 compares the MAC value received from reception unit 31 with the MAC value calculated by itself to determine whether the Offer message has been tampered with.

When processing unit 33 determines that vehicle-mounted ECU 111 specified by the endpoint information or the like acquired from the Offer message is registered in the connection destination list and that the Offer message has not been tampered with, processing unit 33 determines that the Offer message received by reception unit 31 is appropriate. On the other hand, when vehicle-mounted ECU 111 specified by the endpoint information or the like acquired from the Offer message is not registered in the connection destination list, or when processing unit 33 determines that the Offer message has been tampered with, processing unit 33 determines that the Offer message received by reception unit 31 is inappropriate.

When determining that the Offer message received by reception unit 31 is appropriate, processing unit 33 stores the ECU identifier and the endpoint information acquired from the Offer message in storage unit 35 as the server information. Further, processing unit 33 outputs the Offer message to transmission unit 32.

Transmission unit 32 multicasts the Offer message received from processing unit 33 to the plurality of clients. For example, transmission unit 32 refers to the connection destination list in storage unit 35 and performs multicasting to the plurality of clients that may need the service whose service ID is “0x0001”.

On the other hand, when processing unit 33 determines that the Offer message received by reception unit 31 is inappropriate, processing unit 33 outputs the Offer message to log generation unit 34. Log generation unit 34 records information relating to messages determined to be inappropriate by processing unit 33.

Storage unit 35 stores invalid log list R11 which is a list of invalid logs indicating a byte string of a message determined to be inappropriate by processing unit 33, the ECU identifier of vehicle-mounted ECU 111 serving as the source of the message, and a reception time of the message. Invalid log list R11 is a list having the same contents as invalid log list R1 shown in FIG. 8.

Log generation unit 34 receives the Offer message from processing unit 33, acquires the ECU identifier included in the received Offer message and the time stamp indicating the reception time, and writes the byte string of the Offer message and the acquired ECU identifier and reception time into invalid log list R11 in storage unit 35 as an invalid log. Thereafter, log generation unit 34 discards the Offer message.

### (1-3) Transmission of Subscribe Message by Client

Referring back to FIG. 5, in vehicle-mounted ECU 111 serving as the client, communication unit 11 receives the Offer message from management device 201 and outputs the received Offer message to processing unit 12.

Processing unit 12 receives the Offer message from communication unit 11 and acquires the service ID from the received Offer message. Processing unit 12 refers to the service list in storage unit 13 and determines whether the service indicated by the acquired service ID is necessary. When determining that the service is necessary, processing unit 12 outputs a reply instruction to communication unit 11. On the other hand, when determining that the service is unnecessary, processing unit 12 does not output the reply instruction.

After receiving the reply instruction from processing unit 12, communication unit 11 acquires the ECU identifier and the endpoint information of its own vehicle-mounted ECU 111 from storage unit 13. Then, communication unit 11 generates a Subscribe message including the ECU identifier and the endpoint information, and transmits the generated Subscribe message to management device 201.

### (1-4) Determination of Session Establishment by Management Device

Referring back to FIG. 16, reception unit 31 in management device 201 receives the Subscribe message from the client and outputs the received Subscribe message to processing unit 33.

Processing unit 33 receives the Subscribe message from reception unit 31 and acquires the ECU identifier and the endpoint information from the received Subscribe message. Processing unit 33 stores the acquired ECU identifier and endpoint information in storage unit 35 as client information.

Processing unit 33 determines to establish the session between the server and the client indicated by the server information and the client information stored in storage unit 35. When determining to establish the session, processing unit 33 generates session key K and distributes it to the server and the client.

For example, when processing unit 33 does not receive the Subscribe message from the client via reception unit 31 until a predetermined time elapses after transmitting the Offer message to the client via transmission unit 32, processing unit 33 transmits a message indicating that there is no client requiring the service to the server via transmission unit 32.

### (1-5) Session Key Distribution by Management Device

Processing unit 33 generates session key K used in the session determined to be established and a key ID which is an ID of session key K, and distributes generated session key K and key ID to the server and the client attending the session.

For example, processing unit 33 encrypts session key K using the unique ID as the encryption key. Further, for example, processing unit 33 calculates hash value HV calculated using the unique ID and session key K.

More specifically, processing unit 33 refers to the connection destination list in storage unit 35, acquires the unique ID of the server indicated by the server information, and encrypts session key K using the acquired unique ID as the encryption key, thereby generating encrypted key KS which is encrypted session key K for the server. Then, processing unit 33 includes encrypted key KS and the corresponding key ID in the Subscribe message received from the client, and calculates hash value HVS by applying the Subscribe message and the acquired unique ID to a predetermined hash function. Note that processing unit 33 may further include information indicating that there is a client that needs a service in the Subscribe message.

Further, processing unit 33 refers to the connection destination list in storage unit 35, acquires the unique ID of the client indicated by the client information, and encrypts session key K using the acquired unique ID as an encryption key, thereby generating encrypted key KC which is encrypted session key K for the client. Then, processing unit 33 generates start message MC including the endpoint information of the server, encrypted key KC, and the corresponding key ID, and calculates hash value HVC by applying generated start message MC and the acquired unique ID to a predetermined hash function. Processing unit 33 may include information indicating that there is a server capable of providing a service in start message MC.

Processing unit 33 outputs generated start message MC and Subscribe message, and calculated hash values HVS and HVC to transmission unit 32.

Transmission unit 32 transmits the Subscribe message received from processing unit 33 to the server having the unique ID used for encrypting encrypted key KS. Further, transmission unit 32 transmits start message MC to the client having the unique ID used for encrypting encrypted key KC. Further, transmission unit 32 transmits hash value HVS to the server and transmits hash value HVC to the client.

Processing unit 33 outputs, to log generation unit 34, session information indicating the service ID of the service provided in the session to be established, the ECU identifier of the server that is the destination of the Subscribe message, the ECU identifier of the client that is the destination of start message MC, and output time ts of the Subscribe message and start message MC. Output time ts indicates the transmission time of session key K by transmission unit 32.

Log generation unit 34 records session information about the session in which session key K generated by processing unit 33 is used.

Storage unit 35 stores a session log list R12 which is a list of session logs indicating the service ID of the service provided in the session to be established, each ECU identifier of the server and the client to which session key K is distributed, the start time of the session, and the end time of the session. Session log list R12 is a list having the same contents as session log list R12 shown in FIG. 9.

Log generation unit 34 receives the session information from processing unit 33 and writes the service ID, the ECU identifier, and output time ts included in the received session information into session log list R12 as the “service ID”, the “ECU identifier”, and the “start time” of the session log, respectively.

Referring back to FIG. 5, in the server, communication unit 11 receives the Subscribe message and hash value HVS from management device 201 and outputs them to processing unit 12. Processing unit 12 compares hash value HVS from management device 201 received by communication unit 11 with the hash value calculated using session key K from management device 201 received by communication unit 11 and its own unique ID.

More specifically, processing unit 12 receives the Subscribe message and hash value HVS from communication unit 11, acquires the unique ID from storage unit 13, and calculates the hash value by applying the received Subscribe message and the acquired unique ID to a predetermined hash function. Processing unit 12 compares hash value HVS with the hash value calculated by itself to determine whether the Subscribe message has been tampered with.

When processing unit 12 determines that the Subscribe message has been tampered with, processing unit 12 discards the Subscribe message. On the other hand, when processing unit 12 determines that the Subscribe message has not been tampered with, processing unit 12 acquires the endpoint information, encrypted key KS, and the key ID of the client from the Subscribe message. Then, processing unit 12 acquires session key K by decrypting encrypted key KS using the unique ID.

When the key ID of session key K acquired in the past is stored in storage unit 13, processing unit 12 compares the key ID in storage unit 13 with the newly acquired key ID. When processing unit 12 confirms that the key ID in storage unit 13 is different from the newly acquired key ID, processing unit 12 stores the newly acquired endpoint information, session key K, and key ID of the client in storage unit 13.

On the other hand, when the key ID in storage unit 13 matches the newly acquired key ID, processing unit 12 transmits a message requesting retransmission of session key K to management device 201 via communication unit 11. When receiving the message, management device 201 generates new session key K and transmits it to the server and the client. Thus, when same session key K as session key K used in the past session is distributed to the server and the client, it is possible to prompt management device 201 to regenerate session key K, so that it is possible to avoid a decrease in security due to the use of same session key K in different sessions.

Further, in the client, communication unit 11 receives start message MC and hash value HVC from management device 201 and outputs them to processing unit 12. Processing unit 12 compares hash value HVC received from management device 201 by communication unit 11 with the hash value calculated using session key K from management device 201 received by communication unit 11 and its own unique ID.

More specifically, processing unit 12 receives start message MC and hash value HVC from communication unit 11, acquires the unique ID from storage unit 13, and calculates the hash value by applying received start message MC and the acquired unique ID to a predetermined hash function. Processing unit 12 compares hash value HVC with the hash value calculated by itself to determine whether start message MC has been tampered with.

When processing unit 12 determines that start message MC has been tampered with, processing unit 12 discards start message MC. On the other hand, when processing unit 12 determines that start message MC has not been tampered with, processing unit 12 acquires the endpoint information, encrypted key KC, and the key ID of the server from start message MC. Then, processing unit 12 acquires session key K by decrypting encrypted key KC using the unique ID.

When the key ID of session key K acquired in the past is stored in storage unit 13, processing unit 12 compares the key ID in storage unit 13 with the newly acquired key ID. When processing unit 12 confirms that the key ID in storage unit 13 is different from the newly acquired key ID, processing unit 12 stores the newly acquired endpoint information, session key K, and key ID of the server in storage unit 13.

On the other hand, when the key ID in storage unit 13 matches the newly acquired key ID, processing unit 12 transmits a message requesting retransmission of session key K to management device 201 via communication unit 11. When receiving the message, management device 201 generates new session key K and transmits it to the server and the client.

Here, since the number of different session keys K that can be generated in management device 201 is limited, there is a case where management device 201 distributes same session key K as certain session key K with sufficient time after distributing certain session key K. Therefore, processing unit 12 in each of the server and the client deletes the key ID from storage unit 13 after a sufficient time has elapsed since the key ID was stored in storage unit 13.

### (2) Processing Example 2 in Service Discovery

### (2-1) Transmission of Find Message by Client

Referring back to FIG. 5, in vehicle-mounted ECU 111 serving as the client, processing unit 12 refers to the service list in storage unit 13 and acquires the service ID corresponding to the service that vehicle-mounted ECU 111 intends to be provided with. Further, processing unit 12 acquires the ECU identifier and the endpoint information of its own vehicle-mounted ECU 111 from storage unit 13. Processing unit 12 generates a Find message including the acquired service ID, ECU identifier, and endpoint information.

Processing unit 12 calculates a MAC value based on the generated Find message and the unique ID in storage unit 13. Processing unit 12 outputs the generated Find message and the calculated MAC value to communication unit 11.

Communication unit 11 receives the Find message and the MAC value from processing unit 12, and transmits the received Find message and MAC value to management device 201.

### (2-2) Determination of Propriety of Find Message by Management Device

Referring back to FIG. 16, reception unit 31 in management device 201 receives the Find message and the MAC value from the client. Reception unit 31 attaches a time stamp to the received Find message and outputs the Find message and the MAC value to processing unit 33.

Processing unit 33 receives the Find message and the MAC value from reception unit 31 and determines whether the received Find message is appropriate or inappropriate.

More specifically, processing unit 33 acquires the service ID, the endpoint information of vehicle-mounted ECU 111, and the ECU identifier from the Find message. Then, processing unit 33 refers to the connection destination list in storage unit 35 and confirms whether vehicle-mounted ECU 111 specified by the endpoint information and the ECU identifier acquired from the Find message is registered in the connection destination list as a client that can be involved in the service indicated by the service ID acquired from the Find message.

As an example, when the service ID, the endpoint information, and the ECU identifier acquired from the Find message are “0x0001”, “CCC”, and “ECU_3”, respectively, processing unit 33 determines that vehicle-mounted ECU 111 specified by the ECU identifier and the endpoint information is registered in the connection destination list as a client that can be involved in the service indicated by the service ID.

Further, processing unit 33 refers to the connection destination list and acquires the unique ID of vehicle-mounted ECU 111 specified by the endpoint information or the like acquired from the Find message. Processing unit 33 calculates a MAC value based on the Find message and the acquired unique ID. Then, processing unit 33 compares the MAC value received from reception unit 31 with the MAC value calculated by itself to determine whether the Find message has been tampered with.

When processing unit 33 determines that vehicle-mounted ECU 111 specified by the endpoint information or the like acquired from the Find message is registered in the connection destination list and that the Find message has not been tampered with, processing unit 33 determines that the Find message received by reception unit 31 is appropriate. On the other hand, when vehicle-mounted ECU 111 specified by the endpoint information or the like acquired from the Find message is not registered in the connection destination list, or when processing unit 33 determines that the Find message has been tampered with, processing unit 33 determines that the Find message received by reception unit 31 is inappropriate.

When determining that the Find message received by reception unit 31 is appropriate, processing unit 33 stores the ECU identifier and the endpoint information acquired from the Find message in storage unit 35 as the client information. Further, processing unit 33 outputs the Find message to transmission unit 32.

Transmission unit 32 multicasts the Find message received from processing unit 33 to the plurality of servers. For example, transmission unit 32 refers to the connection destination list in storage unit 35 and performs multicasting to the plurality of servers that can provide a service whose service ID is “0x0001”.

On the other hand, when processing unit 33 determines that the Find message received by reception unit 31 is inappropriate, processing unit 33 outputs the Find message to log generation unit 34.

Log generation unit 34 receives the Find message from processing unit 33, acquires the ECU identifier and the time stamp indicating the reception time included in the received Find message, and writes the byte string of the Find message, and the acquired ECU identifier and reception time into invalid log list R11 in storage unit 35 as an invalid log. Thereafter, log generation unit 34 discards the Find message.

### (2-3) Transmission of Offer Message by Server

Referring back to FIG. 5, in vehicle-mounted ECU 111 as the server, communication unit 11 receives the Find message from management device 201 and outputs the received Find message to processing unit 12.

Processing unit 12 receives the Find message from communication unit 11 and acquires the service ID from the received Find message. Processing unit 12 refers to the service list in storage unit 13 and determines whether the service indicated by the acquired service ID can be provided. When determining that the service can be provided, processing unit 12 outputs a reply instruction to communication unit 11. On the other hand, when determining that the service cannot be provided, processing unit 12 does not output the reply instruction.

After receiving the reply instruction from processing unit 12, communication unit 11 acquires the ECU identifier and the endpoint information of its own vehicle-mounted ECU 111 from storage unit 13. Then, communication unit 11 generates an Offer message including the ECU identifier and the endpoint information, and transmits the generated Offer message to management device 201.

### (2-4) Determination of Propriety of Offer Message by Management Device

Management device 201 determines whether the Offer message received from the server is appropriate or inappropriate in the same way as in “(1-2) Determination of Propriety of Offer Message by Management Device” described above. When management device 201 determines that the Offer message is appropriate, it transmits the Offer message to the client.

### (2-5) Transmission of Subscribe Message by Client

Referring back to FIG. 5, vehicle-mounted ECU 111 which is the client transmits the Subscribe message to management device 201 in the same way as in “(1-3) Transmission of Subscribe Message by Client” described above.

### (2-6) Determination of Session Establishment by Management Device

Management device 201 determines to establish the session in the same way as in “(1-4) Determination of Session Establishment by Management Device” described above, generates session key K, and distributes it to the server and the client.

### (2-7) Session Key Distribution by Management Device

Management device 201 distributes session key K and the key ID to the server and the client attending the session in the same way as in “(1-5) Session Key Distribution by Management Device” described above.

Further, the server and the client acquire session key K in the same way as in “(1-5) Session Key Distribution by Management Device” described above.

### (Communication in Session)

The server and the client start the session of communication using session key K.

Specifically, in the server, processing unit 12 encrypts a session message storing information to be provided as a service using session key K in storage unit 13, and outputs the encrypted session message to communication unit 11. Communication unit 11 unicasts the session message received from processing unit 12 to the client indicated by the endpoint information in storage unit 13.

Further, in the client, processing unit 12 decrypts the session message received from the server via communication unit 11 using session key K in storage unit 13, and acquires information from the decrypted session message.

### (Participation in Existing Session)

For example, processing unit 12 in the server regularly or irregularly transmits an Offer message to management device 201 via communication unit 11 even after the start of the session with a certain client.

When processing unit 33 in management device 201 receives the Subscribe message from another client in response to the Offer message of the server via reception unit 31 after the session between the server and the client is established, processing unit 33 determines to establish the session between the server and the another client.

That is, for example, when processing unit 33 distributes session key K1 to server S1 and client C1 and then receives a Subscribe message from client C2 in response to the Offer message of server S1 via reception unit 31, processing unit 33 determines to establish the session between server S1 and client C2.

In this case, for example, processing unit 33 generates session key K2 different from session key K1 distributed to server S1 and client C1 as session key K used in the session between server S1 and client C2, and distributes generated session key K2 to server S1 and client C2.

That is, processing unit 33 generates and distributes different session key K for each combination of a server and a client.

(Multicasting from Server to Client)

In vehicle-mounted system 302, the server is not limited to the configuration of unicasting the session message to the client. The server may be configured to multicast a session message to the plurality of clients.

More specifically, when the number of clients performing communication in the session with one server reaches a predetermined number, processing unit 33 in management device 201 generates session key KM which is session key K used in the session between the server and the plurality of clients, and distributes generated session key KM to the server and the plurality of clients.

That is, for example, when processing unit 33 receives a Subscribe message from client C3 in response to an Offer message of server S1 via reception unit 31 in a state where two sessions between server S1 and clients C1 and C2 are established, processing unit 33 generates session key K3 used in the session between server S1 and client C3 and distributes session key K3 to server S1 and client C3. Further, processing unit 33 further generates session key KM used in the session between server S1 and clients C1, C2, and C3 and a multicasting address based on the endpoint information of server S1 and clients C1, C2, and C3, and distributes generated session key KM and multicasting address to server S1 and clients C1, C2, and C3.

When server S1 and clients C1, C2, and C3 acquire session key KM and the multicasting address, server S1 and clients C1, C2, and C3 start the session of communication using session key KM and the multicasting address.

Referring back to FIG. 7, server S1 has session key K1 used in the session with client C1, session key K2 used in the session with client C2, session key K3 used in the session with client C3, and session key KM used in the session with clients C1, C2, and C3. Client C1 has session key K1, KM. Client C2 has session key K2, KM. Client C3 has session key K3, KM.

In server S1, processing unit 12 encrypts a session message containing information to be provided as a service using session key KM, and multicasts the encrypted session message to clients C1, C2, and C3 via communication unit 11.

For example, server S1 is configured to, in response to detecting abnormality in vehicle-mounted system 302 in a state of transmitting information to clients C1, C2, and C3 by multicasting, change the state to a state of transmitting information to the plurality of clients C1, C2, and C3 by unicasting.

As an example, a case is considered in which an invalid device that has taken over client C1 pretends to be server S1 and multicasts a session message encrypted using session key KM to server S1 and clients C2 and C3.

When processing unit 12 in server S1 receives the session message from the invalid device via communication unit 11, processing unit 12 determines that abnormality has occurred in vehicle-mounted system 302 because processing unit 12 itself has received the session message even though processing unit 12 itself is the source of the session message.

In this case, processing unit 12 in server S1 switches the transmission of the session message from multicasting to unicasting. Specifically, processing unit 12 unicasts the session message encrypted using session key K1 to client C1 via communication unit 11, unicasts the session message encrypted using session key K2 to client C2 via communication unit 11, and unicasts the session message encrypted using session key K3 to client C3 via communication unit 11.

(End of Session from Client Side)

When the client stops receiving the provision of the service, processing unit 12 encrypts a StopSubscribe message including the service ID using session key K in storage unit 13 and transmits it to management device 201 via communication unit 11. Further, processing unit 12 discards session key K and the endpoint information of the server in storage unit 13.

Referring back to FIG. 16, in management device 201, reception unit 31 receives the StopSubscribe message from the client. Reception unit 31 attaches a time stamp to the received StopSubscribe message and outputs the message to processing unit 33. The StopSubscribe message from the client received by reception unit 31 is an example of the end-request.

Processing unit 33 receives the StopSubscribe message from reception unit 31, and outputs the received StopSubscribe message to transmission unit 32. Further, processing unit 33 notifies log generation unit 34 of reception time te indicated by the time stamp attached to the StopSubscribe message.

In response to the receipt of the StopSubscribe message by reception unit 31, transmission unit 32 transmits the StopSubscribe message for ending the session to another vehicle-mounted ECU 111 attending the session, that is, the server. More specifically, transmission unit 32 transmits the StopSubscribe message received from processing unit 33 to the server. The StopSubscribe message to the server transmitted by transmission unit 32 is an example of the end instruction.

Referring back to FIG. 16, log generation unit 34 receives notification of reception time te from processing unit 33, and writes notified reception time te as “end time” of the session log into session log list R12.

In the server, processing unit 12 receives the StopSubscribe message from management device 201 via communication unit 11, and decrypts the received StopSubscribe message using session key K in storage unit 13. Processing unit 12 discards session key K and the endpoint information of the client in storage unit 13.

(End of Session from Server Side)

When the server stops providing the service, processing unit 12 encrypts a StopOffer message including the service ID using session key K in storage unit 13 and transmits the reservation message to management device 201 via communication unit 11. Further, processing unit 12 discards session key K and the endpoint information of the client in storage unit 13.

Referring back to FIG. 16, in management device 201, reception unit 31 receives the StopOffer message from the client. Reception unit 31 attaches a time stamp to the received StopOffer message and outputs the message to processing unit 33. The StopOffer message from the server received by reception unit 31 is an example of the end-request.

Processing unit 33 receives the StopOffer message from reception unit 31, and outputs the received StopOffer message to transmission unit 32. Further, processing unit 33 notifies log generation unit 34 of reception time te indicated by the time stamp attached to the StopOffer message.

When the StopOffer message is received by reception unit 31, transmission unit 32 transmits a StopOffer message indicating that the session should be ended to another vehicle-mounted ECU 111 attending the session, that is, the client. More specifically, transmission unit 32 transmits the StopOffer message received from processing unit 33 to the client. The StopOffer message to the client transmitted by transmission unit 32 is an example of the end instruction.

Referring back to FIG. 6, log generation unit 34 receives notification of reception time te from processing unit 33, and writes notified reception time te as “end time” of the session log into session log list R12.

In the client, processing unit 12 receives the StopOffer message from management device 201 via communication unit 11, and decrypts the received StopOffer message using session key K in storage unit 13. Processing unit 12 discards session key K and the endpoint information of the server in storage unit 13.

### [Operation Flow]

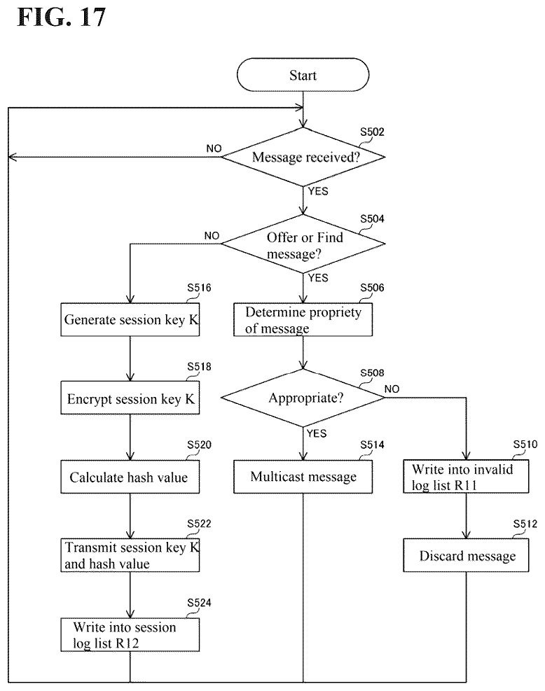

FIG. 17 is a flowchart defining an example of an operation procedure when the management device distributes a session key according to the second embodiment of the present disclosure.

Referring to FIG. 17, first, management device 201 waits for an Offer message from the server, a Find message from the client, or a Subscribe message from the client (NO in step S502).

Next, when the Offer message from the server or the Find message from the client is received (YES in step S502 and YES in step S504), management device 201 determines whether the received message is appropriate or inappropriate (step S506).

Next, when management device 201 determines that the received message is inappropriate (NO in Step S508), it acquires the ECU identifier and the time stamp indicating the reception time included in the message, and writes the byte string of the message and the acquired ECU identifier and reception time into invalid log list R11 as an invalid log (Step S510).

Next, management device 201 discards the message (step S512) and waits for a new message from the server or the client (NO in step S502).

On the other hand, when determining that the received message is appropriate (YES in step S508), management device 201 multicasts the message. More specifically, management device 201 multicasts the message to the plurality of clients when the message is an Offer message, and multicasts the message to the plurality of servers if the message is a Find message (step S512).

On the other hand, when receiving the Subscribe message from the client (YES in step S502 and NO in step S504), management device 201 determines to establish the session between the server and the client, and generates session key K and a key ID to be used in the session (step S516).

Next, management device 201 encrypts session key K. More specifically, management device 201 generates encrypted key KS by encrypting session key K using the unique ID of the server as an encryption key. Further, management device 201 generates encrypted key KC by encrypting session key K using the unique ID of the client as an encryption key (step S518).

Next, management device 201 calculates a hash value (step S520).

More specifically, management device 201 includes encrypted key KS in the Subscribe message, and applies the Subscribe message and the unique ID of the server to a predetermined hash function to calculate hash value HVS. Further, management device 201 generates start message MC including encrypted key KC, and calculates hash value HVC by applying generated start message MC and the unique ID of the client to a predetermined hash function.

Next, management device 201 transmits session key K and the hash value. More specifically, management device 201 transmits the Subscribe message including encrypted key KS and hash value HVS to the server, and transmits start message MC including encrypted key KC and hash value HVC to the client (step S522).

Next, management device 201 writes the service ID of the service provided in the session to be established, each ECU identifier of the server and the client that are the destinations of session key K, and the start time of the session into session log list R12 as the “service ID”, the “ECU identifier”, and the “start time” of the session log, respectively (step S524).

Next, management device 201 waits for a new Offer message from the server, a new Find message from the client, or a new Subscribe message from the client (NO in step S502).

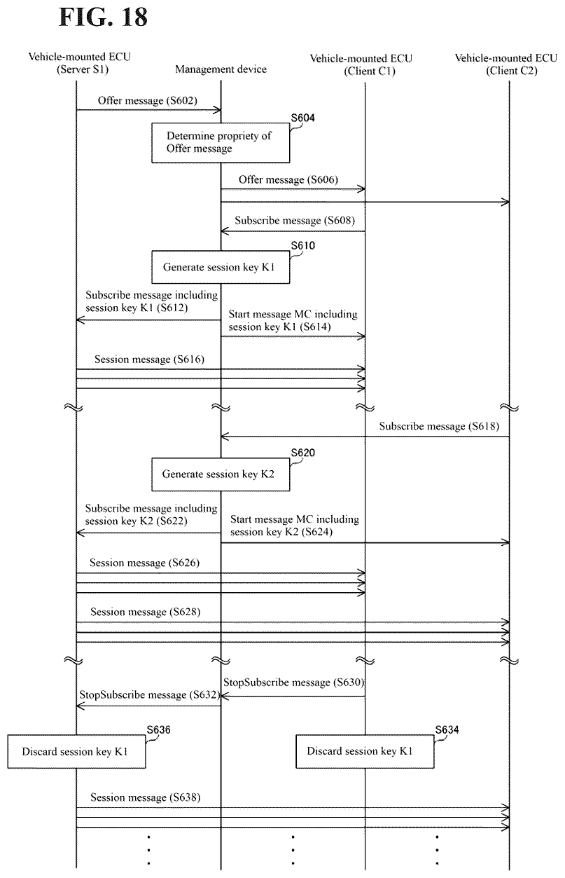

FIG. 18 is a diagram showing an example of a sequence of communication in the vehicle-mounted system according to the second embodiment of the present disclosure.

Referring to FIG. 18, first, server S1 transmits an Offer message to management device 201 (step S602).

Next, management device 201 determines whether the Offer message received from server S1 is appropriate or inappropriate (step S604).

Next, when determining that the Offer message is appropriate, management device 201 multicasts the Offer message to clients C1 and C2 (step S606).

Next, for example, client C1 acquires the service ID from the Offer message received from management device 201, determines that the service indicated by the acquired service ID is necessary, and transmits a Subscribe message to management device 201 (step S608).

Next, management device 201 receives the Subscribe message from client C1, determines to establish the session between server S1 and client C1, and generates session key K1 to be used in the session (step S610). At this time, management device 201 writes the service ID of the service provided in the session to be established, each ECU identifier of server S1 and client C1, and the start time of the session into session log list R12 as the “service ID”, the “ECU identifier”, and the “start time” of the session log, respectively.

Next, management device 201 includes generated session key K1 in a Subscribe message and distributes the message to server S1 (step S612). In addition, management device 201 includes generated session key K1 in start message MC and distributes it to client C1 (step S614).

Next, server S1 unicasts the session message encrypted using session key K1 to client C1, for example, periodically (step S616).

Next, for example, client C2 acquires the service ID from the Offer message received from management device 201, determines that the service indicated by the acquired service ID is necessary, and transmits a Subscribe message to management device 201 (step S618).

Next, management device 201 receives the Subscribe message from client C2, determines to establish the session between server S1 and client C2, and generates session key K2 to be used in the session (step S620). At this time, management device 201 writes the service ID of the service provided in the session to be established, each ECU identifier of server S1 and client C2, and the start time of the session into session log list R12 as the “service ID”, the “ECU identifier”, and the “start time” of the session log, respectively.

Next, management device 201 includes generated session key K2 in a Subscribe message and distributes the message to server S1 (step S622). In addition, management device 201 includes generated session key K2 in start message MC and distributes it to client C2 (step S624).

Next, server S1 unicasts the session message encrypted using session key K1 to client C1, for example, periodically (step S626).

Also, server S1 unicasts the session message encrypted using session key K2 to client C2, for example, periodically (step S628).

Next, for example, client C1 transmits a StopSubscribe message to management device 201 in order to stop receiving the provision of the service (step S630).

Next, management device 201 receives the StopSubscribe message from client C1 and transmits the StopSubscribe message to server S1 (step S632). Further, at this time, management device 201 writes the end time of the session into session log list R12 as the “end time” of the session log.

Next, client C1 discards session key K1 and the endpoint information of server S1 in storage unit 13 (step S634).

Further, server S1 discards session key K1 and the endpoint information of client C1 in storage unit 13 (step S636).

Next, server S1 continues unicasting the session message to client C2 (step S638).

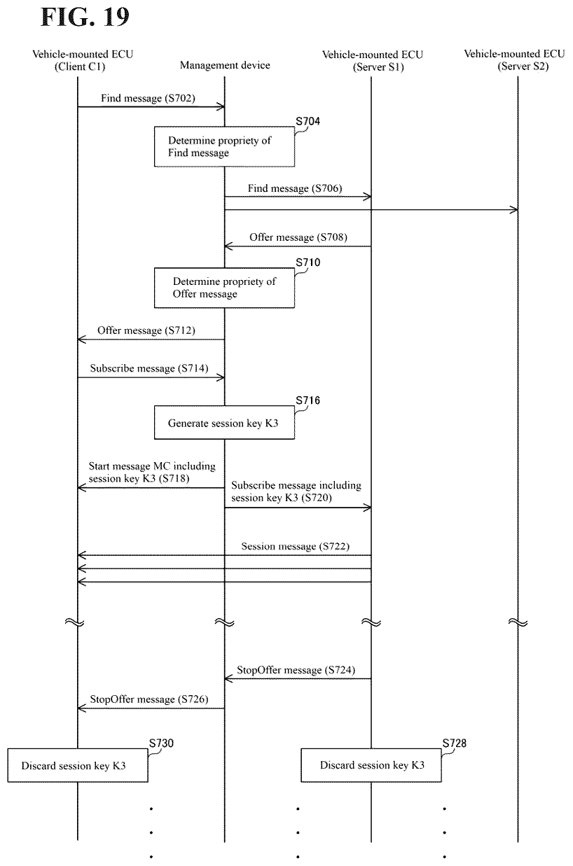

FIG. 19 is a diagram showing another example of a sequence of communication in the vehicle-mounted system according to the second embodiment of the present disclosure.

Referring to FIG. 19, first, client C1 transmits a Find message to management device 201 (step S702).

Next, management device 201 determines whether the Find message received from client C1 is appropriate or inappropriate (step S704).

Next, when determining that the Find message is appropriate, management device 201 multicasts the Find message to servers S1 and S2 (step S706).

Next, for example, server S1 acquires the service ID from the Find message received from management device 201, determines that the service indicated by the acquired service ID can be provided, and transmits an Offer message to management device 201 (step S708).

Next, management device 201 determines whether the Offer message received from server S1 is appropriate or inappropriate (step S710).

Next, when determining that the Offer message is appropriate, management device 201 transmits the Offer message to client C1 (step S712).

Next, client C1 receives the Offer message from management device 201, and transmits a Subscribe message to management device 201 (step S714).

Next, management device 201 receives the Subscribe message from client C1, determines to establish the session between server S1 and client C1, and generates session key K3 to be used in the session (step S716). At this time, management device 201 writes the service ID of the service provided in the session to be established, each ECU identifier of server S1 and client C1, and the start time of the session into session log list R12 as the “service ID”, the “ECU identifier”, and the “start time” of the session log, respectively.

Next, management device 201 includes generated session key K1 in start message MC and distributes it to client C1 (step S718). Further, management device 201 includes generated session key K3 in a Subscribe message and distributes the message to server S1 (step S720).

Next, server S1 unicasts the session message encrypted using session key K3 to client C1, for example, periodically (step S722).

Next, for example, server S1 transmits a StopOffer message to management device 201 in order to stop providing the service (step S724).

Next, management device 201 receives the StopOffer message from server S1, and transmits the StopOffer message to client C1 (step S726). Further, at this time, management device 201 writes the end time of the session into session log list R12 as the “end time” of the session log.

Next, server S1 discards session key K3 and the endpoint information of client C1 in storage unit 13 (step S728).

Further, client C1 discards session key K3 and the endpoint information of server S1 in storage unit 13 (step S730).

Instead of server S1 transmitting the StopOffer message to management device 201 in step S724 in FIG. 19, client C1 may transmit the StopSubscribe message to management device 201. Also, instead of client C1 transmitting the StopSubscribe message to management device 201 in step S630 in FIG. 18, server S1 may transmit the StopOffer message to management device 201. In this case, management device 201 transmits a StopOffer message to clients C1 and C2.

In vehicle-mounted system 302 according to the second embodiment of the present disclosure, the server is configured to, in response to detecting abnormality in vehicle-mounted system 302 in a state of transmitting information to the plurality of clients by multicasting, change the state to a state of transmitting information to the plurality of clients by unicasting, but the present disclosure is not limited thereto. The server may be configured not to change the state to a state of transmitting information to the plurality of clients by unicasting. Further, the server may be configured to transmit information to the plurality of clients by unicasting but not to transmit information by multicasting.

Further, in management device 201 according to the second embodiment of the present disclosure, processing unit 33 is configured to output the Subscribe message including encrypted key KS and start message MC including encrypted key KC to transmission unit 32, but the present disclosure is not limited thereto. Processing unit 33 may be configured to output the Subscribe message and start message MC including unencrypted session key K to transmission unit 32. In this case, transmission unit 32 transmits the Subscribe to the server and transmits start message MC to the client.

In addition, in management device 201 according to the second embodiment of the present disclosure, transmission unit 32 is configured to transmit hash value HVS to the server and transmit hash value HVC to the client, but the present disclosure is not limited thereto. Transmission unit 32 may be configured not to transmit hash value HVS while transmitting the Subscribe message to the server. Further, transmission unit 32 may be configured not to transmit hash value HVC while transmitting start message MC to the client.

Further, in management device 201 according to the second embodiment of the present disclosure, reception unit 31 is configured to receive the StopSubscribe message from the client and receive the StopOffer message from the server, but the present disclosure is not limited thereto. Reception unit 31 may be configured not to receive the StopSubscribe message and the StopOffer message. In this case, for example, in vehicle-mounted system 302, the client transmits the StopSubscribe message to the server instead of transmitting the StopSubscribe message to management device 201. Further, the server transmits the StopOffer message to the client instead of transmitting the StopOffer message to management device 201.

In addition, management device 201 according to the second embodiment of the present disclosure includes log generation unit 34, but the present disclosure is not limited thereto. Management device 201 may not include log generation unit 34.

In addition, in management device 201 according to the second embodiment of the present disclosure, log generation unit 34 is configured to write the start time and the end time of the session into session log list R12, but the present disclosure is not limited thereto. Log generation unit 34 may be configured to write the service ID of the service provided in the session, the ECU identifier of the server which is the destination of the Subscribe message, and the ECU identifier of the client which is the destination of start message MC into session log list R12, but not to write the start time and the end time of the session into session log list R12.

In management device 201 according to the second embodiment of the present disclosure, processing unit 33 is configured to generate session key K having random contents on a session-by-session basis, but the present disclosure is not limited thereto. Processing unit 33 may be configured to generate session key K having a regular content on a session-by-session basis.

Further, in management device 201 according to the second embodiment of the present disclosure, processing unit 33 may be configured to further determine whether the Subscribe message is appropriate or inappropriate, may be configured to further determine whether the StopSubscribe message is appropriate or inappropriate, or may be configured to further determine whether the StopOffer message is appropriate or inappropriate, similarly to processing unit 23 in relay device 101 according to the first embodiment.

Meanwhile, there is a demand for a technology capable of further improving security in a vehicle-mounted network. More specifically, for example, in a vehicle-mounted system that performs service-oriented communication, a technique capable of further improving security in the vehicle-mounted network is desired.

On the other hand, in management device 201 according to the second embodiment of the present disclosure, reception unit 31 receives the Offer message from the server. Further, reception unit 31 receives a Subscribe message from the client. Processing unit 33 generates session key K that is used in the session associated with the Offer message and the Subscribe message received by reception unit 31 and is unique to the session. Transmission unit 32 transmits the session key generated by processing unit 33 to the server and the client attending the session.

As described above, according to the configuration in which the Offer message is received from the server, the Subscribe message is received from the client, and session key K unique to the session is generated and transmitted to the server and the client, it is possible to perform communication between the server and the client using individual session key K on a session-by-session basis, thereby improving the security of communication between the server and the client. Further, for example, by performing authentication of the server serving as the source of the Offer message and the client serving as the source of the Find message, it is possible to detect the Offer message and the Find message from the invalid device. Therefore, it is possible to further improve security in the vehicle-mounted network.

Further, in management device 201, when the number of clients performing communication in the session with one server reaches a predetermined number, processing unit 33 generates session key KM to be used in the session between the server and the plurality of clients, and distributes the generated session key KM to the server and the plurality of clients. This configuration enables multicasting communication using session key KM for the server and the plurality of clients. Therefore, it is possible to improve security in a vehicle-mounted network in which messages are transmitted and received in accordance with SOME/IP.

It should be understood that the above-described embodiments are illustrative in all respects and are not restrictive. The scope of the present invention is defined not by the above description but by the claims, and is intended to include all modifications within the meaning and scope equivalent to the claims.

The above description includes the following additional features.

### [Supplementary Note 1]

A vehicle-mounted relay device includes a relay unit configured to perform relay processing of transmitting each of a plurality of frames received from a corresponding one of a plurality of vehicle-mounted devices to a corresponding one of the plurality of vehicle-mounted devices serving as destinations; a determination unit configured to determine that the plurality of frames include a start-request for starting a session of communication between the plurality of vehicle-mounted devices and that the plurality of frames include a start-response to the start-request; a generation unit configured to generate, on a session-by-session basis, a common key to be used in the session attended by, among the plurality of vehicle-mounted devices, a vehicle-mounted device serving as a source of the frame determined to include the start-request by the determination unit and one or more vehicle-mounted devices serving as a source of the frame determined to include the start-response by the determination unit; and a transmission unit configured to transmit the common key via the relay unit to the respective vehicle-mounted devices that are to attend the session. The relay unit receives the first frame including a service ID, endpoint information of the vehicle-mounted device of the source of the start-request, and an ECU identifier of the vehicle-mounted device of the source of the start-request. The generation unit determines whether the first frame is appropriate or inappropriate based on the service ID, the endpoint information, and the ECU identifier. The relay unit receive a second frame including a service ID, endpoint information of the vehicle-mounted device of the source of the start-response, and an ECU identifier of the vehicle-mounted device of the source of the start-response. The generation unit determines whether the second frame is appropriate or inappropriate based on the service ID, the endpoint information, and the ECU identifier.

### [Supplementary Note 2]

A vehicle-mounted system includes a plurality of vehicle-mounted devices, and a vehicle-mounted relay device. The vehicle-mounted relay device is configured to perform relay processing of transmitting each of a plurality of frames received from a corresponding one of the plurality of vehicle-mounted devices to a corresponding one of the plurality of vehicle-mounted devices serving as destinations. The first vehicle-mounted device that is one of the plurality of vehicle-mounted devices is configured to transmit, to the vehicle-mounted relay device, a first frame including a start-request for starting a session of communication between multiple vehicle-mounted devices. The second vehicle-mounted device that is one of the plurality of vehicle-mounted devices is configured to transmit, to the vehicle-mounted relay device, a second frame including a start-response to the start-request. The vehicle-mounted relay device is configured to generate, on a session-by-session basis, a common key to be used in the session attended by the first vehicle-mounted device serving as a source of the first frame that has been received and the second vehicle-mounted device serving as a source of the second frame that has been received, and transmit the generated common key to the respective vehicle-mounted devices that are to attend the session. The first vehicle-mounted device transmits the first frame to the vehicle-mounted relay device, the first frame including a service ID, endpoint information of the first vehicle-mounted device, and an ECU identifier of the first vehicle-mounted device. The vehicle-mounted relay device determines whether the first frame is appropriate or inappropriate based on the service ID, the endpoint information, and the ECU identifier. The second vehicle-mounted device transmits the second frame to the vehicle-mounted relay device, the second frame including a service ID, endpoint information of the second vehicle-mounted device, and an ECU identifier of the second vehicle-mounted device. The vehicle-mounted relay device determines whether the second frame is appropriate or inappropriate based on the service ID, the endpoint information, and the ECU identifier.

### [Supplementary Note 3]

A management device used in a vehicle-mounted system including a plurality of vehicle-mounted devices includes a reception unit configured to receive a start-request for starting a session of communication between multiple vehicle-mounted devices which are some or all of the plurality of the vehicle-mounted devices, the start-request being received from a corresponding one of the vehicle-mounted devices; a generation unit configured to generate a common key, the common key being to be used in the session associated with the start-request and being unique to the session; and a transmission unit configured to transmit the common key to the respective vehicle-mounted devices that are to attend the session. The reception unit receives the start-request including a service ID, endpoint information of the vehicle-mounted device of the source of the start-request, and an ECU identifier of the vehicle-mounted device of the source of the start-request. The generation unit determines whether the start-request is appropriate or inappropriate based on the service ID, the endpoint information, and the ECU identifier.

### [Supplementary Note 4]

A vehicle-mounted system includes a plurality of vehicle-mounted devices, and a management device. The vehicle-mounted device is configured to transmit, to the management device, a start-request for starting a session of communication between multiple vehicle-mounted devices which are some or all of the plurality of vehicle-mounted devices. The management device is configured to generate a common key, the common key being to be used in the session associated with the start-request that have been received and being unique to the session, and transmit the generated common key to the respective vehicle-mounted devices that are to attend the session. The vehicle-mounted device is configured to transmit the start-request including the service ID, the endpoint information of the vehicle-mounted device, and the ECU identifier of the vehicle-mounted device to the management device. The management device is configured to determine whether the start-request is appropriate or inappropriate based on the service ID, the endpoint information, and the ECU identifier.

### REFERENCE SIGNS LIST

1 vehicle
11 communication unit
12 processing unit
13 storage unit
14 cable
21 communication port
22 relay unit
23 processing unit (determination unit, generation unit, transmission unit)
24 log generation unit (recording unit)
25 storage unit
31 reception unit
32 transmission unit
33 processing unit
34 log generation unit
35 storage unit
101 relay device (vehicle-mounted relay device)
102 relay device
111 vehicle-mounted ECU (vehicle-mounted device)
201 management device
301, 302 vehicle-mounted system
R1, R11 invalid log list
R2, R12 session log list
S1 server
C1, C2, C3 client

1. A vehicle-mounted relay device comprising:
a relay circuit configured to perform relay processing of transmitting each of a plurality of frames received from a corresponding one of a plurality of vehicle-mounted devices to a corresponding one of the plurality of vehicle-mounted devices serving as destinations;
a determination circuit configured to determine that the plurality of frames include a start-request for starting a session of communication between the plurality of vehicle-mounted devices and that the plurality of frames include a start-response to the start-request;
a generation circuit configured to generate, on a session-by-session basis, a common key to be used in the session attended by, among the plurality of vehicle-mounted devices, a vehicle-mounted device serving as a source of the frame determined to include the start-request by the determination circuit and one or more vehicle-mounted devices serving as a source of the frame determined to include the start-response by the determination circuit; and
a transmission circuit configured to transmit the common key via the relay circuit to the respective vehicle-mounted devices that are to attend the session.

2. The vehicle-mounted relay device according to claim 1, further comprising:
a storage circuit configured to store unique IDs of the respective vehicle-mounted devices, wherein
the transmission circuit is configured to transmit the common key, the common key having been encrypted using one of the unique IDs as an encryption key, via the relay circuit to the vehicle-mounted device having the unique ID used for encryption.

3. The vehicle-mounted relay device according to claim 2, wherein the transmission circuit is configured to further transmit a hash value, the hash value being calculated using one of the unique IDs and the common key, via the relay circuit to the vehicle-mounted device having the unique ID used for calculating the hash value.

4. The vehicle-mounted relay device according to claim 1, further comprising:
a recording circuit configured to record session information about the session in which the common key is used.

5. The vehicle-mounted relay device according to claim 4, wherein the recording circuit is configured to record, as the session information, a time at which the common key is transmitted by the relay circuit.

6. The vehicle-mounted relay device according to claim 4, wherein
the determination circuit is configured to determine that one of the plurality of frames received by the relay circuit includes an end-request for ending the session, and
the recording circuit is configured to record, as the session information, a time at which the frame including the end-request is received by the relay circuit.

7. The vehicle-mounted relay device according to claim 1, wherein
the determination circuit is configured to, in accordance with a determination result indicating that one of the plurality of frames received by the relay circuit includes the start-request or the start-response, determine whether the frame is appropriate or inappropriate, and
the relay circuit is configured to, in accordance with a determination result of the determination circuit indicating whether the frame is appropriate or inappropriate, perform the relay processing or discarding of the frame.

8. A management device used in a vehicle-mounted system including a plurality of vehicle-mounted devices, the management device comprising:
a reception circuit configured to receive a start-request for starting a session of communication between multiple vehicle-mounted devices which are some or all of the plurality of vehicle-mounted devices, and a start-response to the start-request, the start-request and the start-response each being received from a corresponding one of the multiple vehicle-mounted devices;
a generation circuit configured to generate a common key, the common key being to be used in the session associated with the start-request and the start-response and being unique to the session; and
a transmission circuit configured to transmit the common key to the respective vehicle-mounted devices that are to attend the session.

9. The management device according to claim 8, further comprising:
a storage circuit configured to store unique IDs of the respective vehicle-mounted devices, wherein
the transmission circuit is configured to transmit the common key, the common key having been encrypted using one of the unique IDs as an encryption key, to the vehicle-mounted device having the unique ID used for encryption.

10. The management device according to claim 9, wherein the transmission circuit is configured to further transmit a hash value, the hash value being calculated using one of the unique IDs and the common key, to the vehicle-mounted device having the unique ID used for calculating the hash value.

11. The management device according to claim 8, wherein
the reception circuit is configured to receive an end-request for ending the session from one of the multiple vehicle-mounted devices, and
the transmission circuit is configured to, in response to receipt of the end-request by the reception circuit, transmit an end instruction to end the session to another or others of the multiple vehicle-mounted devices attending the session.

12. The management device according to claim 8, further comprising:
a recording circuit configured to record session information about the session in which the common key is used.

13. The management device according to claim 12, wherein the recording circuit is configured to record, as the session information, a time at which the common key is transmitted by the transmission circuit.

14. The management device according to claim 11, further comprising:
a recording circuit configured to record session information about the session in which the common key is used, wherein
the recording circuit is configured to record, as the session information, a time at which the end-request is received by the reception circuit.

15. A vehicle-mounted system comprising:
a plurality of vehicle-mounted devices including a first vehicle-mounted device and a second vehicle-mounted device; and
a vehicle-mounted relay device, wherein
the vehicle-mounted relay device is configured to perform relay processing of transmitting each of a plurality of frames received from a corresponding one of the plurality of vehicle-mounted devices to a corresponding one of the plurality of vehicle-mounted devices serving as destinations,
the first vehicle-mounted device is configured to transmit, to the vehicle-mounted relay device, a first frame including a start-request for starting a session of communication between multiple vehicle-mounted devices which are some or all of the plurality of vehicle-mounted devices,
the second vehicle-mounted device is configured to transmit, to the vehicle-mounted relay device, a second frame including a start-response to the start-request, and
the vehicle-mounted relay device is configured to generate, on a session-by-session basis, a common key to be used in the session attended by the first vehicle-mounted device serving as a source of the first frame that has been received and the second vehicle-mounted device serving as a source of the second frame that has been received, and transmit the generated common key to the respective vehicle-mounted devices that are to attend the session.

16. The vehicle-mounted system according to claim 15, wherein the vehicle-mounted relay device is connected to the first vehicle-mounted device and the second vehicle-mounted device without via another relay device.

17. The vehicle-mounted system according to claim 15, wherein each of the plurality of vehicle-mounted devices is configured to, in response to detecting abnormality in the vehicle-mounted system in a state of transmitting information to the plurality of vehicle-mounted devices by multicasting, change the state to a state of transmitting information to the plurality of vehicle-mounted devices by unicasting.

18. The vehicle-mounted system according to claim 15, wherein
the vehicle-mounted relay device includes a storage circuit configured to store unique IDs of the respective vehicle-mounted devices in the vehicle-mounted system,
the vehicle-mounted relay device is configured to further transmit a hash value, the hash value being calculated using one of the unique IDs and the common key, to the vehicle-mounted device having the unique ID used for calculating the hash value, and
the vehicle-mounted device is configured to compare the hash value received from the vehicle-mounted relay device with a hash value calculated using the common key received from the vehicle-mounted relay device and the unique ID of the vehicle-mounted device.

19. A vehicle-mounted system comprising:
a plurality of vehicle-mounted devices including a first vehicle-mounted device and a second vehicle-mounted device; and
a management device, wherein
the first vehicle-mounted device is configured to transmit, to the management device, a start-request for starting a session of communication between multiple vehicle-mounted devices which are some or all of the plurality of vehicle-mounted devices,
the second vehicle-mounted device is configured to transmit, to the management device, a start-response to the start-request, and
the management device is configured to generate a common key, the common key being to be used in the session associated with the start-request and the start-response that have been received and being unique to the session, and transmit the generated common key to the respective vehicle-mounted devices that are to attend the session.

20. The vehicle-mounted system according to claim 19, wherein each of the plurality of vehicle-mounted devices is configured to, in response to detecting abnormality in the vehicle-mounted system in a state of transmitting information to the plurality of vehicle-mounted devices by multicasting, change the state to a state of transmitting information to the plurality of vehicle-mounted devices by unicasting.

21. The vehicle-mounted system according to claim 19, wherein
the management device includes a storage circuit configured to store unique IDs of the respective vehicle-mounted devices in the vehicle-mounted system,
the management device is configured to further transmit a hash value, the hash value being calculated using one of the unique IDs and the common key, to the vehicle-mounted device having the unique ID used for calculating the hash value, and
the vehicle-mounted device is configured to compare the hash value received from the management device with a hash value calculated using the common key received from the management device and the unique ID of the vehicle-mounted device.

22.-25. (canceled)
